(19) United States
(12) Patent Application Publication
(10) Pub. No.: US 2026/0126823 A1
(43) Pub. Date: May 7, 2026

(54) CROSS-STAGE SENSING VOLTAGE REGULATION

(71) Applicant: Microsoft Technology Licensing, LLC, Redmond, WA (US)

(72) Inventor: Vlad Radu CALUGARU, Lake Stevens, WA (US)

(21) Appl. No.: 18/937,700

(22) Filed: Nov. 5, 2024

(51) Int. Cl. G05F 1/575; G05F 1/565

(52) U.S. Cl. CPC G05F 1/575; G05F 1/565

(57) ABSTRACT

An example electrical system includes a first voltage regulator, a second voltage regulator, a cross-stage sensing path, and a cross-stage voltage regulation mechanism. The cross-stage sensing path is external to an input line of the first voltage regulator and connected to an output line of the second voltage regulator. The cross-stage voltage regulation mechanism is connected to the cross-stage sensing path and configured to regulate an outgoing voltage of the first voltage regulator in response to receipt through at least the cross-stage sensing path of an outgoing voltage from the second voltage regulator output line. The cross-stage voltage regulation mechanism includes a mode switch or a control loop. Some variations include more than two voltage regulators, more than one cross-stage sensing path, more than one cross-stage voltage regulation mechanism, temperature sensing, and combinations thereof.

### BACKGROUND

Many modern systems and devices in a broad range of fields utilize electric power, including lighting devices, heating and cooling systems, air filter devices, pumps, refrigeration devices, kitchen appliances, industrial machinery, robots, electronic devices such as computers, televisions, radios, and videogame systems, vehicles such as vehicles operating underwater, on the surface of water, on roads, off roads, in the air, and in space, satellites, private and public transportation systems, medical devices, scientific research devices, military defense systems, and communication devices, among many others. Different devices have different operational requirements for the electric power they use.

Accordingly, a variety of approaches to electrical power regulation have been developed. However, improvements in electrical power regulation technology are still possible.

### SUMMARY

Some embodiments address technical challenges arising in electrical power regulation, and more particularly in voltage regulation. One challenge is how to optimize the handling of voltage dips, voltage spikes, and other transient events in a power supply system that includes multiple voltage regulators arranged serially in a cascade. Another challenge is how to reduce response times for mode switches, control loops, and other control elements in a power supply system. Other technical challenges are also addressed herein.

Some embodiments taught herein provide or utilize cross-stage voltage regulation technology in an electrical system which includes voltage regulators with respective input lines and output lines. The electrical system includes a first voltage regulator in a first voltage regulation stage, the first voltage regulator having an input line, having an output line, and being configured to provide a first voltage on the output line. The electrical system also includes a second voltage regulator in a second voltage regulation stage, the second voltage regulator having an input line, having an output line, and being configured to provide a second voltage on the output line. The second voltage is different from the first voltage. The electrical system also includes a cross-stage sensing path which is external to the second voltage regulator input line, external to the first voltage regulator output line, and electrically connected to the second voltage regulator output line. A cross-stage voltage regulation mechanism is electrically connected to the cross-stage sensing path and configured to regulate the first voltage in response to receipt (by way of the cross-stage sensing path) of at least the second voltage.

By transmitting voltage information across stages through the cross-stage sensing path, these examples permit faster responses to transient events or other voltage changes than would be possible by relying only on propagation through the input and output lines (sometimes referred to as ripple propagation). Faster responses in turn provide benefits such as reduced power dissipation, better anticipation of computer processor power requirements, redundancy, and more efficient use of electric power.

Additional technical activities, technical characteristics, and technical benefits pertinent to teachings herein will also become apparent to those of skill in the art. The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. Subject matter scope is defined with claims as properly understood, and to the extent this Summary conflicts with the claims, the claims should prevail.

### BRIEF DESCRIPTION OF THE DRAWINGS

A more particular description will be given with reference to the attached drawings. These drawings only illustrate selected aspects and thus do not fully determine coverage or scope.

FIG. 1 is a diagram illustrating aspects of computer systems, including some aspects generally suitable for embodiments which include or use cross-stage voltage regulation (CSVR) functionality;

FIG. 2 is a block diagram illustrating aspects of a family of enhanced systems which are each configured with CSVR functionality;

FIG. 3 is a circuit diagram of a single voltage regulator stage;

FIG. 4 is a circuit diagram of a two-stage voltage regulator enhanced with a cross-stage sensing line and a junction;

FIG. 5 is a schematic diagram of an enhanced two-stage voltage regulator which includes a cross-stage sensing path, in which the individual stages each include an in-stage sensing path;

FIG. 6 is a schematic diagram of an enhanced two-stage voltage regulator which includes a cross-stage sensing path and a mode switch external to both of the individual stages;

FIG. 7 is a schematic diagram of an enhanced two-stage voltage regulator which includes an external cross-stage sensing path and a mode switch internal to one of the individual stages;

FIG. 8 is a schematic diagram of an enhanced two-stage voltage regulator which includes a cross-stage sensing path and a control loop external to both of the individual stages;

FIG. 9 is a schematic diagram of an enhanced two-stage voltage regulator which includes an external cross-stage sensing path and a control loop internal to one of the individual stages;

FIG. 10 is a schematic diagram of an enhanced two-stage voltage regulator which includes an external cross-stage sensing path, a supplemental sensing path, a junction, and a control loop;

FIG. 11 is a schematic diagram of an enhanced N-stage voltage regulator, N greater than 2, which includes multiple cross-stage sensing paths;

FIG. 12 is a schematic diagram of an enhanced voltage regulator which has a tree topology with multiple branches and multiple cross-stage sensing paths;

FIG. 13 is a schematic diagram illustrating a one-to-many topology;

FIG. 14 is a schematic diagram illustrating a many-to-one topology;

FIG. 15 is a schematic diagram of an enhanced two-stage voltage regulator which includes microcontrollers;

FIG. 16 is a block diagram illustrating some aspects of some electrical systems which perform voltage regulation;

FIG. 17 is a flowchart illustrating some CSVR methods; and

FIG. 18 is a flowchart further illustrating CSVR methods, and incorporating as options the steps of FIG. 17 and other steps discussed herein.

### DETAILED DESCRIPTION

### Overview

Some teachings described herein were motivated by technical challenges faced and insights gained during efforts to improve Microsoft X Box power supplies. These challenges and insights provided some motivations, but the teachings herein are not limited in their scope or applicability to these particular tools, motivational challenges, solutions, or insights.

Many electrical systems include a cascading hierarchy of step-down voltage regulators (VRs), also referred to collectively as a “cascade”. In one example, a server rack in a data center receives power at 54V, steps that 54V down to 20V using a first buck converter, steps the 20V to 12V using a second buck converter in series with the first buck converter, and provides the 12V to server blades. The 12V is stepped down in turn to 5V, which is stepped down to supply voltages between 0.8V and 1.4V to integrated circuits. This is only one example. The exact voltages and the number of converters in a cascade vary depend on the incoming voltage to the cascade, the voltage regulators, and the equipment fed by the cascade. Buck converters, boost converters, and voltage inverters are each an example of a voltage regulator.

In this VR cascade example and generally elsewhere herein, “first” and “second” distinguish items without necessarily indicating a relative position in time or in space. For example, in some scenarios an upstream voltage regulator is the first voltage regulator and a downstream voltage regulator is the second voltage regulator, but in other scenarios the voltage regulators are in parallel, or they are neither in a serial cascade nor in parallel but are in different branches of a tree topology.

Moreover, some electrical systems include boost converters, inverters, or combinations of various types of voltage regulators, not only buck converters. Some include both a boost (step-up) 1822 converter and a buck (step-down) 1824 converter. In addition, series cascades are not the only voltage regulation topology. In some electrical systems voltage regulators are combined in various topologies such as tree topologies or parallel topologies, instead of (or in addition to) a series topology.

Also, servers and other computing systems are only some of the examples of electrical systems that include or rely on voltage regulators. Voltage regulators are also used with systems that do not have the processor - memory combination that characterizes computing systems, such as the electrical systems of many lighting devices, motors, pumps, heaters, presses, fences, welders, electroplaters, and other equipment.

Individual voltage regulators in a combination of two or more voltage regulators are referred to herein as “stages” of the combination, regardless of the combination's topology. Because the combination as a whole also performs voltage regulation, the combination is also a voltage regulator. Any electrically connected subset of the combination's voltage regulators is also a voltage regulator, because it takes in at least one voltage and outputs at least one voltage and it regulates voltage by more than whatever regulation occurs as an incidental result of power consumption or power dissipation or grounding.

In a voltage regulator that contains two or more constituent voltage regulators, a change in an output voltage of one of the voltage regulators sometimes propagates through one of the constituent voltage regulators to another of the constituent voltage regulators. The voltage change may be caused by, or be indicative of, spikes or other transients, the addition of a load, the removal of a load, a designed or accidental voltage level change, a designed or accidental power level change, a thermal event, a magnetic event, a bend or a break or another physical change in a conductor, or another electrical event. As one example, in the cascade described above in one scenario a short circuit drops the 5V output of one VR stage to zero volts, and that sudden change propagates upstream through the 12V-to-5V converter to the 20V-to-12V converter. In response, voltage regulation circuitry in the 20V-to-12V converter attempts to compensate for the voltage drop.

In another example, two voltage regulators are connected in series and they each step a voltage down. In this cascading VR system, the first VR steps from 24V to 12V, and the second VR steps from 12V to 6V. In this example, the second VR (12V->6V) has a constant load of 10 A. As a result, the first VR has a constant load of 5 A. In a constant load condition, both VRs can enter a high efficiency mode, where either they shut off phases (auto phase shedding), or vary the power frequency, or implement other VR control schemes.

Then the second VR (6V, 10A) experiences a high transient event, doubling its load from 10 A to 20 A. This forces a voltage drop defined by the load line characteristics of the VR, and also affects the voltage at the second VR input, which is electrically connected to the output of the first VR. Thus, a cascading effect results from the transient event at the load, propagating through the series of cascading VRs. In this example there are two VR stages, but some electrical systems include more than two VR stages in a cascade. When this load change reaches the first VR, it is also exposed to the load line characteristics of the first VR and thus the voltage would drop by some amount, depending on what mode the VR is in. If the first VR in this example is in a high-efficiency mode, it will take longer to react to the first VR load than it would if it was in a high-performance mode.

Several technical approaches can be considered in response to these examples or similar examples of how multi-stage VR systems behave in response to transient events. A first approach attempts to reduce or eliminate the likelihood of transient events. A second approach attempts to reduce the time spent by the upstream VRs responding to the propagated effects of transient events. Each of these approaches is generally worth considering. Neither of these approaches is inherently incompatible with some different approaches which are described herein.

Some approaches described herein focus on effectively and efficiently providing upstream VR stages 136 with information about downstream events 222 such as transients, voltage level changes, or power level changes. Some embodiments provide such information more rapidly than would occur when relying only on propagation of the event's effects through the VR input and output lines that operate as a normal part of the cascade's voltage step-downs. This speed allows the upstream VR to respond faster with a mode change or other response to an event at the output of a downstream VR.

A transmission of information about a downstream event is accomplished in some embodiments using a cross-stage sensing path. A cross-stage sensing path is a sensing path which is external to the upstream VR output line and the downstream VR input line, and carries information (analog or digital) from the output side of the downstream VR up to the upstream VR. A sensing path is an electrical connection which carries analog or digital information. A digital bus is a path, and serves as a sensing path when it carries digital information about voltage, temperature, or another condition of a downstream VR output line. When a sensing path only carries analog information, it is also referred to as a sensing line. For instance, a solitary trace on a printed circuit board is a line, and it serves as a sensing line when it carries analog information about voltage, temperature, or another condition of a downstream VR output line.

Some embodiments described herein include a sensing line between a first stage VR and a second stage VR output. The sensing line allows the first stage VR to directly and quickly sense load transient effects that hit the second stage VR output, instead of waiting for the impact of the load transient to propagate more slowly and indirectly to the first stage VR through the second stage VR. A technical advantage of this approach is that the first VR stage reacts faster to the second stage load change 222. With this kind of cross-stage sensing architecture, the first VR can enter or exit high-efficiency modes or high-performance modes (or other modes) much faster than if the sensing line was absent. Cross-stage sensing increases efficiency and increases performance when needed, because it goes beyond reacting slowly and passively to the input voltage drop. Cross-stage sensing helps prepare the first VR for the cascading effects of the load, allowing the first VR to enter or exit modes more accurately.

This increases efficiency and performance of the VRs, and saves on inter-stage capacitance or other energy storage, such as capacitance in the output of the first VR and input of second VR, for example.

Many electrical systems include multiple layers or levels of VRs. For example, many systems start power regulation in an AC-to-DC power supply of a computer, console, or server, for instance, and then perform voltage regulation downstream of the power supply. Cross-stage sensing can be used in different layers of such an architecture, e.g., in or across layers such as a power supply unit (PSU) to bus voltage layer, a bus to smaller points of load layer, a bus to bus divider, a bus to system-on-a-chip (SoC) layer, from a SoC to other chips, from a PSU to a SoC, and so on.

Some embodiments described herein utilize or provide a cross-stage voltage regulation method. The method is performed in an electrical system which includes an upstream voltage regulator in an upstream voltage regulation stage and a downstream voltage regulator in a downstream voltage regulation stage. The upstream voltage regulator has an upstream voltage regulator output line. The downstream voltage regulator has a downstream voltage regulator input line and a downstream voltage regulator output line. The downstream voltage regulator input line is electrically connected to receive an incoming downstream voltage which is regulated at least in part by the upstream voltage regulator. The electrical system also includes a cross-stage sensing path and a cross-stage voltage regulation mechanism. The cross-stage sensing path is external to the downstream voltage regulator input line and electrically connects the downstream voltage regulation stage to the upstream voltage regulation stage. These example method embodiments include: the electrical system transmitting an outgoing downstream voltage from the downstream voltage regulator output line through at least the cross-stage sensing path to the cross-stage voltage regulation mechanism, and the cross-stage voltage regulation mechanism regulating an outgoing upstream voltage of the upstream voltage regulator output line in response to at least the transmitted outgoing downstream voltage. Mode switches and control loops are two examples of voltage regulation mechanisms which can serve as the cross-stage voltage regulation mechanism.

This cross-stage voltage regulation (CSVR) functionality has a technical benefit of preparing the upstream voltage regulator for the effects of a change in the downstream voltage, e.g., by allowing the upstream voltage regulator to enter or exit power modes more accurately, or allowing a control loop to operate sooner, thereby increasing the reliability of the electrical system. This CSVR functionality also increases the efficiency and performance of the voltage regulators. This CSVR functionality also saves on inter-stage capacitance, such as capacitance in the output of the upstream voltage regulator and input of downstream voltage regulator, for example. This CSVR functionality also provides a redundancy in the electrical system to notify the upstream voltage regulator of events that inhibit, damage, or incapacitate the downstream voltage regulator.

In some embodiments, a cross-stage sensing propagation time is less than half of a stage-by-stage propagation time. The cross-stage sensing propagation time is defined as a first elapsed time between a voltage change on the downstream voltage regulator output line and an arrival via at least the cross-stage sensing path of a corresponding sensed voltage change at the voltage regulation mechanism of the upstream voltage regulator. The stage-by-stage propagation time is defined as second elapsed time between the voltage change on the downstream voltage regulator output line and an arrival via at least the downstream voltage regulator input line and the upstream voltage regulator output line of a corresponding responsive voltage change at a connection of the upstream voltage regulator output line to the upstream voltage regulator.

This CSVR functionality has a technical benefit of quantifying a reduction in upstream response time gained by use of the cross-stage sensing path. Knowledge of absolute or relative durations of different electrical activities is helpful during circuit design, and also helpful during circuit testing and circuit operation.

In some embodiments, regulating an outgoing upstream voltage of the upstream voltage regulator output line in response to at least the transmitted outgoing downstream voltage includes adjusting the upstream voltage regulator and thereby reducing a difference between a reference voltage and the outgoing upstream voltage. This CSVR functionality has a technical benefit of improving upstream voltage regulator performance, as measured by adherence to the reference voltage.

In some embodiments, regulating an outgoing upstream voltage of the upstream voltage regulator output line in response to at least the transmitted outgoing downstream voltage includes switching a mode of the upstream voltage regulator and thereby changing a current on the upstream voltage regulator output line. This CSVR functionality has a technical benefit of improving upstream voltage regulator performance, as measured by the accuracy of matching modes and currents to circuit conditions.

In some embodiments, the cross-stage sensing path includes a voltage sensing line connectable to the downstream voltage regulator output line, and the cross-stage sensing path further includes at least one of: a current sensing path, a temperature sensing path, or an energy usage meter. This CSVR functionality has a technical benefit of providing recent downstream current, temperature, or energy usage data, thus making that recent downstream information available as inputs to one or more of a mode switch, a control loop, or another upstream voltage regulation mechanism.

In some embodiments, the system has a topology which includes a tree having branches, and the first voltage regulator is on a different branch than the second voltage regulator. This CSVR functionality has a technical benefit of providing recent voltage, current, temperature, or energy usage data about the output of the second voltage regulator when such information would either not be propagated to the first voltage regulator or would be severely distorted or attenuated during propagation, e.g., due to line length, intervening components, power supply rejection ratio impact, or other items. This CSVR functionality makes the information available as cleaner input to one or more of a mode switch, a control loop, or another voltage regulation mechanism that regulates output from the first voltage regulator.

In some embodiments, at least one of the upstream voltage regulator or the downstream voltage regulator includes an on-die voltage regulator. This CSVR functionality has a technical benefit of providing one voltage regulator stage with recent voltage, current, temperature, or energy usage data about the output of another voltage regulator stage, in a compact package which is electrically and mechanically compatible with placement into a circuit on a printed circuit board.

These and other advantages and benefits will be apparent to one of skill from the teachings provided herein.

### Operating Environments

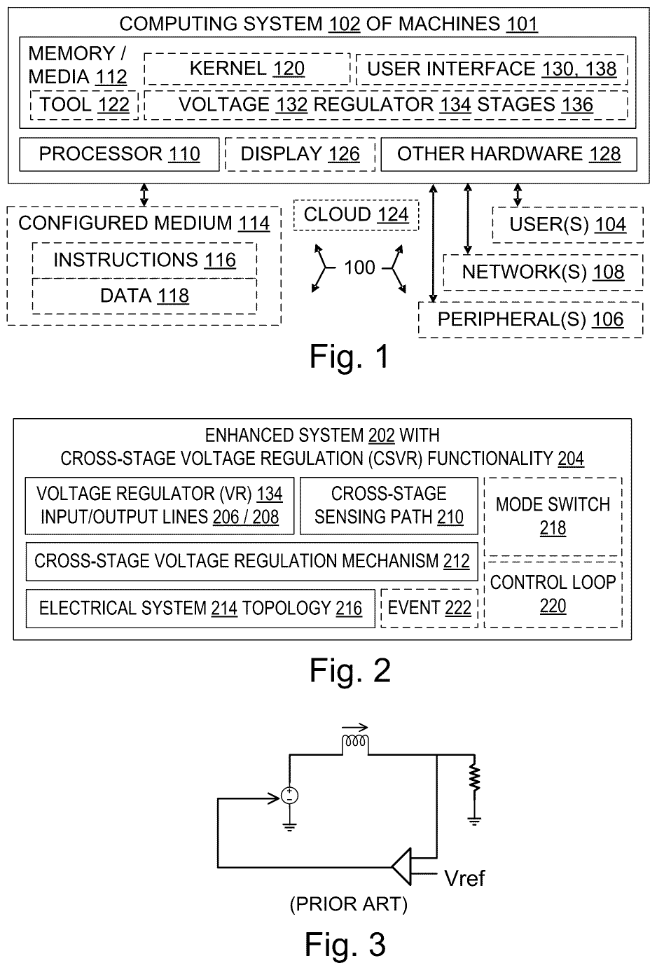

With reference to FIG. 1, an operating environment 100 for an example embodiment includes at least one computer system 102. The computer system 102 may be a multiprocessor computer system, or not. An operating environment may include one or more electrically-powered machines 101 in a given computer system, which may be clustered, client-server networked, and/or peer-to-peer networked within a cloud 124. An individual machine 101 which includes a processor 110 and a digital memory 112 is a computer system, and a network or other non-empty cooperating group of such machines 101 is also a computer system. A given computer system 102 may be configured for end-users, e.g., with applications, for administrators, as a server, as a distributed processing node, and/or in other ways.

System administrators, network administrators, cloud administrators, security analysts and other security personnel, operations personnel, developers, testers, engineers, auditors, and end-users are each a particular type of human user 104. Human users 104 sometimes interact with a computer system 102 user interface by using displays 126, keyboards 106, and other peripherals 106, via typed text, touch, voice, movement, computer vision, gestures, and/or other forms of I/O (input/output). Virtual reality or augmented reality or both functionalities are provided by a system 102 in some embodiments. A screen 126 is a removable peripheral 106 in some embodiments and is an integral part of the system 102 in some embodiments. The user interface supports interaction between an embodiment and one or more human users. In some embodiments, the user interface includes one or more of: a command line interface, a graphical user interface (GUI), natural user interface (NUI), voice command interface, or other user interface (UI) presentations, presented as distinct options or integrated.

Storage devices or networking devices or both are considered peripheral equipment 106 in some embodiments and part of a system 102 in other embodiments, depending on their physical detachability from an electrical connection to the processor 110 hardware. In some embodiments, other computer systems not shown in FIG. 1 interact in technological ways with the computer system 102 or with another system embodiment using one or more connections to a cloud 124 and/or other network 108 via network interface equipment, for example.

Each computer system 102 includes at least one processor 110. The computer system 102, like other suitable systems, also includes one or more computer-readable storage media 112, also referred to as computer-readable storage devices 112. In some embodiments, tools 122 include security tools or software applications, mobile devices 102 or workstations 102 or servers 102, editors, compilers, debuggers and other software development tools, as well as APIs, browsers, or webpages and the corresponding software for protocols such as HTTPS. Files, APIs, endpoints, and other resources may be accessed by an account or non-empty set of accounts, user or non-empty group of users, IP address or non-empty group of IP addresses, or other computational entity.

Storage media 112 occurs in different physical types. Some examples of storage media 112 are volatile memory, nonvolatile memory, fixed in place media, removable media, magnetic media, optical media, solid-state media, and other types of physical durable storage media (as opposed to merely a propagated signal or mere energy). In particular, in some embodiments a configured storage medium 114 such as a portable (i.e., external) hard drive, CD, DVD, memory stick, or other removable nonvolatile memory medium becomes functionally a technological part of the computer system 102 when inserted or otherwise installed, making its content accessible for interaction with and use by processor 110. The removable configured storage medium 114 is an example of a computer-readable storage medium 112. Some other examples of computer-readable storage media 112 include built-in RAM, ROM, hard disks (solid state or magnetic or optical), and other memory storage devices which are not readily removable by users 104. For compliance with current United States patent requirements, neither a computer-readable medium nor a computer-readable storage medium nor a computer-readable memory nor a computer-readable storage device is a signal per se or mere energy under any claim pending or granted in the United States.

A storage device 114 is sometimes configured with binary instructions 116 that are executable by a processor 110; “executable” is used in a broad sense herein to include machine code, interpretable code, and/or code that runs on a virtual machine, for example. The storage medium 114 is also configured with data 118 which is created, modified, referenced, and/or otherwise used for technical effect by execution of the instructions 116. The instructions 116 and the data 118 configure the memory or other storage medium 114 in which they reside; when that memory or other computer readable storage medium is a functional part of a given computer system, the instructions 116 and data 118 also configure that computer system. In some embodiments, a portion of the data 118 is representative of real-world items such as events manifested in the system 102 hardware, product characteristics, inventories, physical measurements, settings, images, readings, volumes, and so forth.

Although an embodiment may include software instructions executed by one or more processors in a computing device (e.g., general purpose computer, server, or cluster), such description is not meant to exhaust all possible embodiments. Embodiments do not necessarily include any software.

One of skill will also understand that the same or similar functionality of software can also often be implemented, in whole or in part, directly in hardware logic, to provide the same or similar technical effects. Alternatively, or in addition to a software implementation, technical functionality can be performed, in some examples, by one or more hardware logic components. For example, and without excluding other implementations, some embodiments include one of more of: chiplets, hardware logic components 110, 128 such as Field-Programmable Gate Arrays (FPGAs), Application-Specific Integrated Circuits (ASICs), Application-Specific Standard Products (ASSPs), System-on-a-Chip (SoC) components, Complex Programmable Logic Devices (CPLDs), and similar components. In some embodiments, components are grouped into interacting functional modules based on their inputs, outputs, or their technical effects, for example.

In addition to processors 110 (e.g., CPUs, ALUs, FPUs, TPUs, GPUs, and/or quantum processors), memory/storage media 112, peripherals 106, and displays 126, some operating environments also include other hardware 128, such as batteries, buses, power supplies, wired and wireless network interface cards, for instance. The nouns “screen” and “display” are used interchangeably herein. In some embodiments, a display 126 includes one or more touch screens, screens responsive to input from a pen or tablet, or screens which operate solely for output. In some embodiments, peripherals 106 such as human user I/O devices (screen, keyboard, mouse, tablet, microphone, speaker, motion sensor, etc.) will be present in operable communication with one or more processors 110 and memory 112.

In some embodiments or operating environments, a system includes multiple computers connected by a wired and/or wireless network 108.

Networking interface equipment 128 can provide access to networks 108, using network components such as a packet-switched network interface card, a wireless transceiver, or a telephone network interface, for example, which are present in some computer systems. In some, virtualizations of networking interface equipment and other network components such as switches or routers or firewalls are also present, e.g., in a software-defined network or a sandboxed or other secure cloud computing environment. In some embodiments or operating environments, one or more computers are partially or fully “air gapped” by reason of being disconnected or only intermittently connected to another networked device or remote cloud. Some examples also communicate technical data or technical instructions or both through direct memory access, removable or non-removable volatile or nonvolatile storage media, or other information storage-retrieval and/or transmission approaches.

One of skill will appreciate that the foregoing aspects and other aspects presented herein under “Operating Environments” form part of some example embodiments, but are not required in every embodiment. This document's headings are not intended to provide a strict classification of features into embodiment and non-embodiment feature sets.

One or more items are shown in outline form in the Figures, or listed inside parentheses, to emphasize that they are not necessarily part of the illustrated operating environment or all embodiments, but interoperate with items in an operating environment or some embodiments as discussed herein. It does not follow that any items which are not in outline or parenthetical form are necessarily required, in any Figure or any embodiment. In particular, FIG. 1 is provided for convenience; inclusion of an item in FIG. 1 does not imply that the item, or the described use of the item, was known prior to the current disclosure.

In any later application that claims priority to the current application, reference numerals may be added to designate items disclosed in the current application. Such items may include, e.g., software, hardware, steps, processes, systems, functionalities, mechanisms, connections, devices, data structures, kinds of data, settings, parameters, components, computational resources, workflows, or algorithm implementations, or other items in a computing environment or another environment containing an electrical system, which are disclosed herein but not associated with a particular reference numeral herein. Corresponding drawings may also be added.

### More About Systems

FIG. 2 illustrates a computing system 102 or other system configured by one or more of the CSVR functionality enhancements taught herein, resulting in an enhanced system 202. Not every enhanced system 202 is a computing system 102; some enhanced systems 202 lack a memory 112, lack a processor 110, or lack both memory 112 and processor 110. In some embodiments, an enhanced system 202 includes a single machine (computational or not), a local network of machines, machines in a particular building, machines used by a particular entity, machines in a particular datacenter, machines in a particular cloud, or another environment 100 that is suitably enhanced as taught herein.

FIG. 3 is a circuit diagram of a single voltage regulator stage which lacks CSVR functionality. This is merely one example of a voltage regulator stage; other voltage regulators include thousands (or more) of other VR circuits 1630. Most if not all such VR circuits are adaptable to operate with CSVR functionality taught herein, e.g., by adding a cross-stage sensing path 210 from an output line of the VR circuit to carry at least voltage information to a different VR stage. In some scenarios, the voltage information reaches the different VR stage directly. In some scenarios the voltage information reaches the different VR stage via an existing or additional voltage regulation mechanism, which serves as a cross-stage voltage regulation mechanism 212 at least by reason of its location on or in the cross-stage sensing path 210. The stage receiving the sensed voltage through the cross-stage sensing path 210 is enabled by the information and by the speed 1828 of receipt, to be informed and active, rather than merely reactive.

In some embodiments, the cross-stage sensing path only carries voltage. Other values, such as current, are often computable from the behavior of the voltage. But some embodiments also provide current or temperature information, or both, directly on the cross-stage sensing path, thereby making those values available faster 1828 than they would be if they had to be derived from a voltage value.

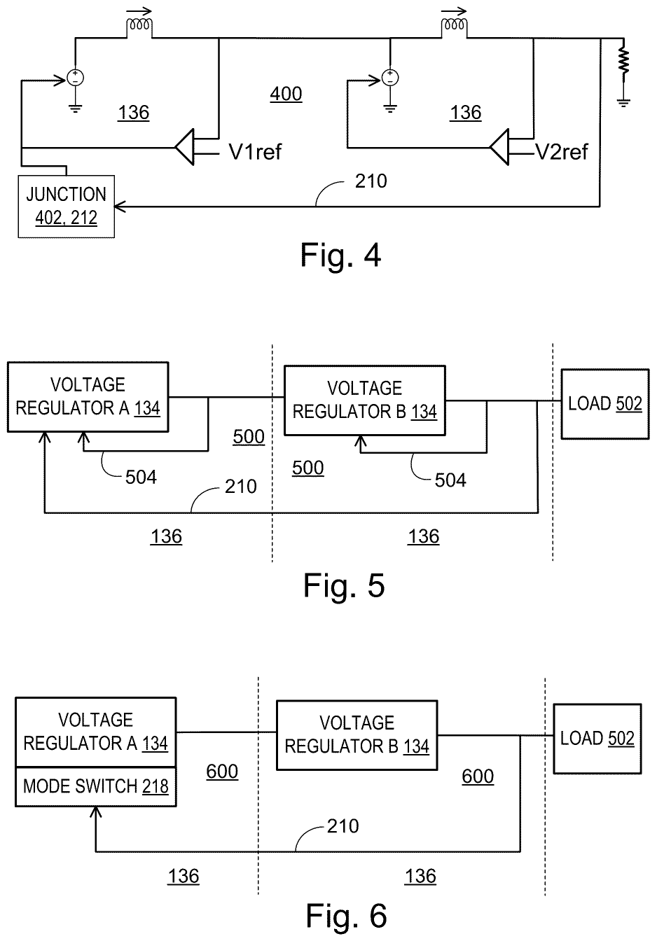

FIG. 4 is a circuit diagram of a two-stage voltage regulator 400, 134 built with two instances of the FIG. 3 circuit, which are enhanced with a cross-stage sensing line 210 and a junction 402. V1ref and V2ref are two different reference voltages. In some embodiments, the junction 402 includes an amplifier. In some embodiments, the junction consists of an amplifier. In some, the junction includes a mode switch 218 as a voltage regulation mechanism 212. In some, the junction includes a control loop 220 as a voltage regulation mechanism 212. In some embodiments, the junction includes both a control loop 220 and a mode switch 218. In some embodiments, a control loop includes an error amplifier, a summing amplifier, or a digital circuit. In some embodiments, the junction 402 includes an artificial intelligence model, e.g., a machine learning model trained on voltages, or voltages and currents, or voltages and temperatures, which outputs control loop operations, or outputs power mode classifications. Although the FIG. 4 example uses the same VR circuit 1630 in each stage 136, in other embodiments different VR circuits 1630 are part of different respective VR stages 136.

A control loop 220 is an error detection mechanism, analog or digital, that tends to minimize an error between what is sensed (output voltage, current, temperature, etc.) and a reference. For example, to maintain 5V on an output, some embodiments sense the output and employ a control loop to adjust the switching behavior of the converter (such as a switching frequency) to minimize the error with respect to the reference.

In the case of a mode switch 218, a lookup table, an artificial intelligence model, or another item is employed to determine when to switch 1806 a mode 1614. In an example, a converter has two modes, denoted here as CCM (constant) and DCM (discontinuous). A sensed voltage (possibly along with sensed current or temperature information, or both) is fed into a deciding block that is capable of switching between CCM and DCM in response to the sensed value(s). In this example, the mode corresponds to a current level. If the sensed current drops below x amps, the deciding block switches the mode from CCM to DCM, and if the current rises above x amps, the deciding block switches from DCM to CCM. These mode switches are part of the behavior of the converter.

FIG. 5 is a schematic diagram of an enhanced two-stage voltage regulator 500, 134 which includes a cross-stage sensing path 210, in which the individual stages 136 each include an in-stage sensing path 504. Unlike a cross-stage sensing path 210, an in-stage sensing path 504 carries voltage information only within a single VR stage 136.

For clarity of illustration and to reduce duplication of drawing elements, the in-stage sensing paths 504 are shown explicitly only in FIG. 5, which shows two in-stage sensing paths 504. But any one or more of the VR stages in any of the embodiments shown in any of FIGS. 4-15 also include an in-stage sensing path 504 in variations which are consistent with that figure.

FIG. 6 is a schematic diagram of an enhanced two-stage voltage regulator 600 which includes a cross-stage sensing path 210 and a mode switch 218 external to both of the individual stages. The mode switch 218 is external to each stage in at least one of: it is physically outside a physical housing containing the stage, it is physically outside an integrated circuit package containing the stage, or it is physically outside a printed circuit board containing the stage.

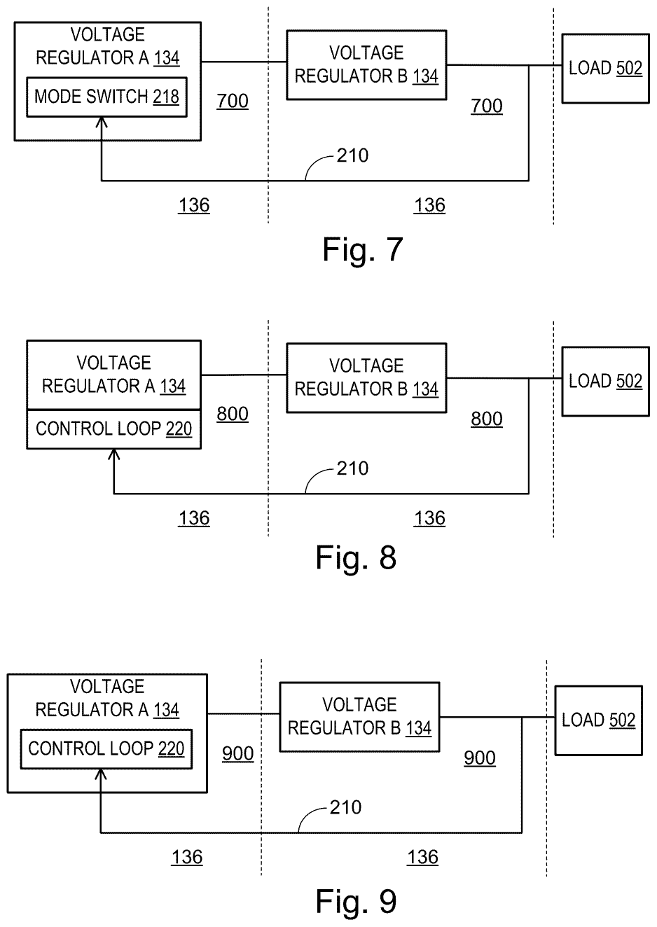

FIG. 7 is a schematic diagram of an enhanced two-stage voltage regulator 700 which includes an external cross-stage sensing path 210 and a mode switch 218 internal to one of the individual stages. The mode switch 218 is internal to the stage in at least one of: it is physically inside a physical housing containing the stage, it is physically inside an integrated circuit package containing the stage, or it is physically on a printed circuit board containing the stage.

FIG. 8 is a schematic diagram of an enhanced two-stage voltage regulator 800 which includes a cross-stage sensing path 210 and a control loop 220 external to both of the individual stages. The control loop 220 is external to each stage in at least one of: it is physically outside a physical housing containing the stage, it is physically outside an integrated circuit package containing the stage, or it is physically outside a printed circuit board containing the stage.

FIG. 9 is a schematic diagram of an enhanced two-stage voltage regulator 900 which includes an external cross-stage sensing path 210 and a control loop 220 internal to one of the individual stages. The control loop 220 is internal to the stage in at least one of: it is physically inside a physical housing containing the stage, it is physically inside an integrated circuit package containing the stage, or it is physically on a printed circuit board containing the stage.

In some embodiments consistent with FIG. 6, FIG. 7, FIG. 8, or FIG. 9, voltage regulator A is fed by a power supply unit (PSU) not shown in the figure. In some, the load 502 shown in the figure is, or includes, a system-on-a-chip (SoC).

In some embodiments consistent with FIG. 6 or FIG. 8, the sensing path 210 is connected on two sides of the mode switch 218 or control loop 220.

Although this is not shown in the FIG. 6 or FIG. 8, a similar two-part sensing path 210 is shown on two sides of the junction 402 in FIG. 4. As noted elsewhere, the specific VR circuits in FIG. 4 are not required in every embodiment; they are some examples of the voltage regulator A and voltage regulator B shown in FIG. 6 and FIG. 8. As also noted elsewhere, the mode switch 218 and the control loop 220 shown in FIG. 6 and FIG. 8 are some examples of the junction 402.

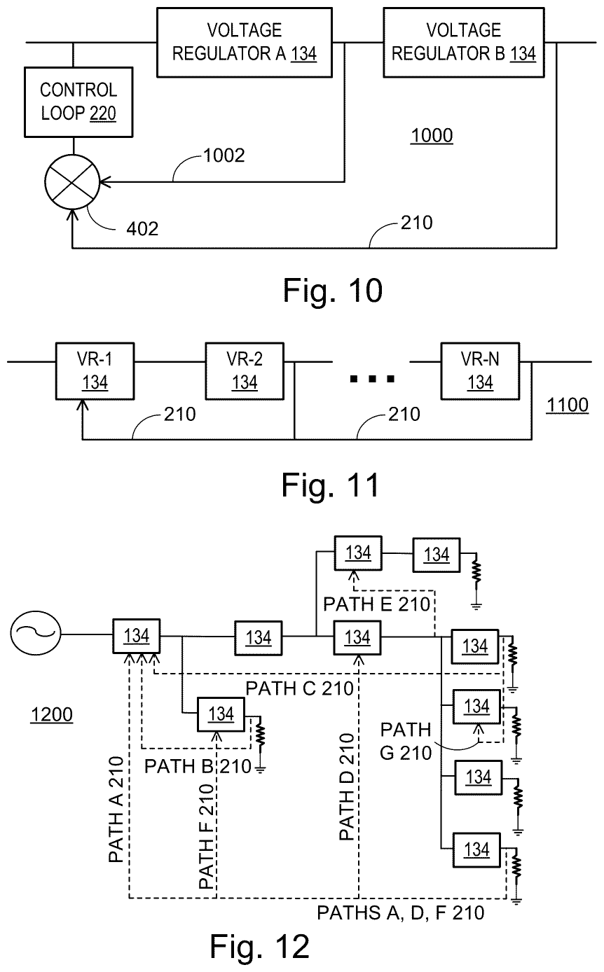

FIG. 10 is a schematic diagram of an enhanced two-stage voltage regulator 1000, 134 which includes an external cross-stage sensing path 210, a supplemental sensing path 1002, a junction 402, and a control loop 220.

FIG. 11 is a schematic diagram of an enhanced N-stage voltage regulator 1100, 134, N being greater than 2, which includes multiple cross-stage sensing paths 210. For clarity of illustration FIG. 11 includes a single horizontal graphical line which represents a portion of the multiple cross-stage sensing paths 210, but in some implementations multiple electrical lines connect respective outputs of stages VR-2 through VR-N to VR-1. Although not shown explicitly in FIG. 11, in some variations the cross-stage sensing paths 210 include or connect to one or more mode switches 218, one or more control loops 220, or both.

FIG. 12 is a schematic diagram of an enhanced voltage regulator 1200, 134 which has a tree topology 216 with multiple branches 1642 and multiple cross-stage sensing paths 210. For clarity of illustration, cross-stage sensing paths 210 are represented graphically in FIG. 12 using dashed lines, but these paths 210 are not intermittent and they do provide electrical connections as indicated. In FIG. 12 the dashes do not indicate that the item is optional, unlike the graphical dashes in FIG. 1 and FIG. 2, but variations of the FIG. 12 example have different topologies 216, different paths 210, or both.

In FIG. 12, cross-stage sensing paths E and G are each an example of a path 210 from the output of a first stage to a second stage in a portion of the topology 216 in which the first stage and the second stage are in parallel 1632 with one another. Path C is an example of a path 210 from the output of a first stage to a second stage in a portion of the topology in which the first stage and the second stage are in series 1634 with one another. Path F is an example of a path 210 from the output of a first stage to a second stage in a portion of the topology in which the first stage and the second stage are in different branches 1642 of a tree 1640. A portion of a topology 216 is itself a topology 216.

As illustrated in FIG. 12, the voltage regulator whose output is sensed doesn't necessarily need to be downstream from the voltage regulator that receives the sensed voltage. The effect of an event on the sensed VR's output is potentially present anywhere on a line connected to the sensed VR, and there can be multiple VRs attached to one line.

As illustrated in FIG. 12, some sensing paths 210 cross 1830 more than one VR stage boundary 1832, thereby providing voltage (and in some scenarios other) information about an event on a first VR's output to a second VR before a ripple propagates to the second VR. Indeed, in some cases the ripple is damped out before it can reach the second VR, or the ripple is so distorted or noisy when it reaches the second VR that it is effectively unusable as guidance for second VR behavior. Some examples of such multi-boundary-crossing sensing paths 210 in FIG. 12 include paths A, B, C, D, and F. A stage boundary 1832 is indicated, e.g., by a difference in the regulated voltages produced by the respective VRs, by different electrical connections of the respective VRs to other components, by separate part numbers or separate schematic boxes assigned to respective VRs, or by a consensus among skilled practitioners, for example.

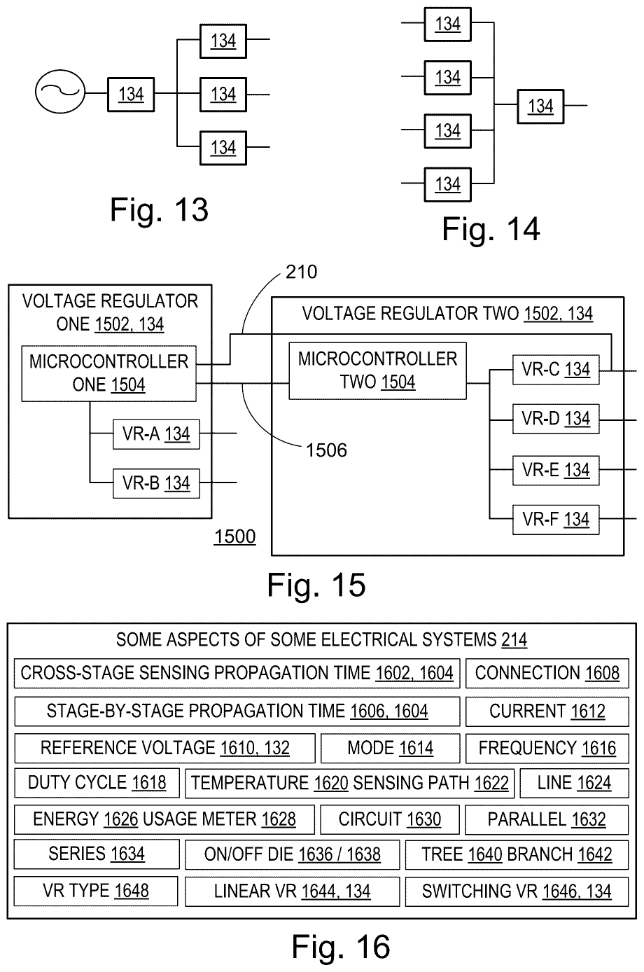

FIG. 13 is a schematic diagram illustrating a one-to-many topology 216. A power source is shown, but in variations the leftmost “one” VR in the one-to-many topology is not directly connected to a power source.

FIG. 14 is a schematic diagram illustrating a many-to-one topology 216. No power source is shown, but one of skill understands that the voltage which is regulated by voltage regulators originates in a power source.

FIG. 15 is a schematic diagram of an enhanced two-stage voltage regulator 1500 which includes microcontrollers 1504 connected by a digital bus 1506. Each microcontroller 1504 resides in a respective on-die 1636 VR stage 1502, 134. In this example VR one 134 is one stage 136 and VR two 134 is another stage 136, and the cross-stage sensing path 210 carries voltage information from an output of VR-C of VR two to VR one. In some scenarios, bus 1506 also carries voltage information, or temperature 1620 information, or both.

FIG. 16 is a block diagram illustrating some aspects of some electrical systems 214 which perform voltage regulation. The illustrated items are discussed at various points herein.

FIGS. 1-16 do not individually or collectively or in any subset fully define a comprehensive summary of all aspects of enhanced systems 202 or all aspects of CSVR functionality 204. Nor is any figure of FIGS. 1-16 or any group of figures of FIGS. 1-16 by itself a comprehensive summary of all aspects of an environment 100 or another context of an enhanced system 202.

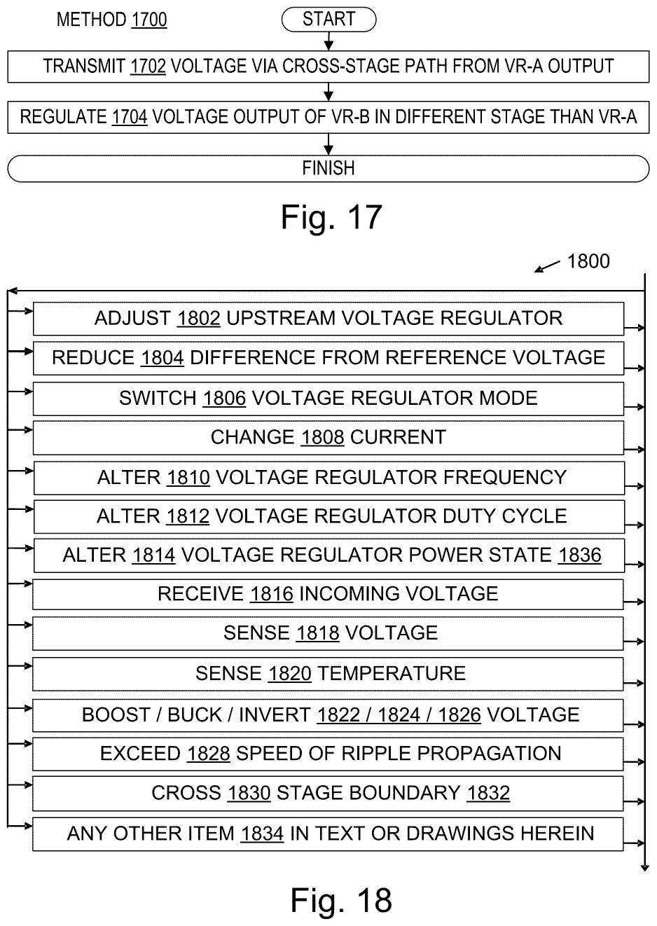

The other figures are also relevant to systems 202. FIGS. 17 and 18 are flowcharts which illustrate some methods of CSVR functionality 204 operation in some systems 202.

In some embodiments, the enhanced system 202 is networked through an interface 138. In some, an interface 138 includes hardware such as network interface cards, software such as network stacks, APIs, or sockets, combination items such as network connections, or a combination thereof.

Some embodiments include a computing system 202 which is configured to utilize or provide CSVR functionality 204. The system 202 includes a digital memory set 112 including at least one digital memory 112, and a processor set 110 including at least one processor 110. The processor set is in operable communication with the digital memory set. A digital memory set is a set which includes at least one digital memory 112, also referred to as a memory 112. The word “digital” is used to emphasize that the memory 112 is part of a computing system 102, not a human person's memory. The word “set” is used to emphasize that the memory 112 is not necessarily in a single contiguous block or of a single kind, e.g., a memory 112 may include hard drive memory as well as volatile RAM, and may include memories that are physically located on different machines 101, but “memory” without set also includes systems with multiple memories. Similarly, the phrase “processor set” is used to emphasize that a processor 110 is not necessarily confined to a single chip or a single machine 101, but “processor”without set also includes systems with multiple processors.

All sets herein are non-empty unless described otherwise.

In this example, a computing system 202 includes at least one processor 110, which is in operable communication with at least one digital memory 112. The at least one digital memory includes volatile storage and non-volatile storage unless indicated otherwise.

Some embodiments include a cross-stage voltage regulation subsystem 202 in an electrical system 214. The electrical system includes an upstream voltage regulator 134 in an upstream voltage regulation stage 136 and a downstream voltage regulator 134 in a downstream voltage regulation stage 136. The upstream voltage regulator has an upstream voltage regulator output line 208. The downstream voltage regulator has a downstream voltage regulator input line 206 and a downstream voltage regulator output line 208. The downstream voltage regulator input line is electrically connected to receive an incoming downstream voltage 132 which is regulated at least in part by the upstream voltage regulator. The voltage regulation subsystem includes: a cross-stage sensing path 210 external to the downstream voltage regulator input line and connectable to the downstream voltage regulator output line, and a cross-stage voltage regulation mechanism 212 connectable to the cross-stage sensing path and configured to regulate an outgoing upstream voltage 132 of the upstream voltage regulator output line in response to receipt through at least the cross-stage sensing path of at least an outgoing downstream voltage 132 from the downstream voltage regulator output line.

In some embodiments, the cross-stage sensing path 210 includes a voltage sensing line connectable to the downstream voltage regulator output line, and the cross-stage sensing path further includes at least one of: a current 1612 sensing path 210, a temperature 1620 sensing path 1622, or an energy 1626 usage meter 1628 (e.g., a Joules 1626 meter 1628).

In some embodiments, the cross-stage voltage regulation mechanism 212 includes at least one of: a mode switch 218, or a control loop 220.

Some embodiments include such a voltage regulation subsystem 202 in an electrically connected combination with the upstream voltage regulator 134 and the downstream voltage regulator 134 to form a combination system 202. In some of these combination systems, the cross-stage sensing path 210 electrically connects the downstream voltage regulator output line to the cross-stage voltage regulation mechanism.

Some combination system embodiments include at least three voltage regulators 134 which have different respective output voltages 132, and which are electrically connected in a serial topology 216. Some examples include VRs connected in series in a step-down cascade.

Some combination system embodiments include at least three voltage regulators 134 which are electrically connected in at least one of: a many-to-one topology 216, or a one-to-many topology 216. Some examples are shown in FIG. 13 (one-to-many), FIG. 14 (many-to-one), and FIG. 12 (including three one-to-many portions).

In some combination system embodiments, at least one of the upstream voltage regulator or the downstream voltage regulator includes an off-die 1638 voltage regulator. In some embodiments, an off-die VR is built and installed as a unit in one box with a housing. Connectors and screw mounts or brackets are provided in or on the housing to electrically and physically connect the off-die VR to a machine and the machine's electrical system.

In some combination system embodiments, at least one of the upstream voltage regulator or the downstream voltage regulator includes an on-die 1636 voltage regulator. In some embodiments consistent with FIG. 15, voltage regulator one and voltage regulator two are each on their own integrated circuit die, and in some both voltage regulator one and voltage regulator two are on the same integrated circuit die. In some embodiments, a neural processing circuit utilized in a control loop or a mode switch resides in its own chip.

In some combination system embodiments, the upstream voltage regulator includes an in-stage upstream voltage sensing line 504 which senses the outgoing upstream voltage of the upstream voltage regulator output line, and the in-stage upstream voltage sensing line is external to the cross-stage sensing path 210 as opposed to overlapping or containing or being contained within the cross-stage sensing path 210.

In some combination system embodiments, the downstream voltage regulator includes an in-stage downstream voltage sensing line 504 which senses the outgoing downstream voltage of the downstream voltage regulator output line, and the in-stage downstream voltage sensing line is external to the cross-stage sensing path 210 as opposed to overlapping or containing or being contained within the cross-stage sensing path 210.

In some embodiments, a cross-stage voltage regulated electrical system 214, 204 includes voltage regulators 134 with respective input lines 206 and output lines 208, and the system 214, 204 includes: a first voltage regulator 134 in a first voltage regulation stage 136, the first voltage regulator having an input line, having an output line, and being configured to provide a first voltage 132 on the output line; a second voltage regulator 134 in a second voltage regulation stage 136, the second voltage regulator having an input line, having an output line, and being configured to provide a second voltage 132 on the output line, the second voltage being different from the first voltage; a cross-stage sensing path 210 which is external to the second voltage regulator input line, external to the first voltage regulator output line, and electrically connected to the second voltage regulator output line; and a cross-stage voltage regulation mechanism 212 electrically connected to the cross-stage sensing path and configured to regulate the first voltage in response to receipt by way of the cross-stage sensing path of at least the second voltage. In this description, “first” and “second” are intended to distinguish items without necessarily indicating a relative position in time or in space.

In general, an electrical system has a topology. The topology is representable as a graph in which edges represent electrical connections, and nodes represent respective voltage regulators, mode switches, control loop controllers (referred to simply as “control loops”), power sources, generalized loads, and other electrical system components.

In some embodiments, the system has a topology 216, the topology includes a tree 1640 having branches 1642, and the first voltage regulator is on a different branch than the second voltage regulator.

In some embodiments, the first voltage regulator is in series 1634 with the second voltage regulator.

In some embodiments, the first voltage regulator is in parallel 1632 with the second voltage regulator.

In some embodiments, the first voltage regulator or the second voltage regulator or both include at least one of: a boost convertor 1648; a buck convertor 1648; or an inverter 1648.

In some embodiments, the first voltage regulator or the second voltage regulator or both include at least one of: a linear voltage regulator 1644, 134; or a switching regulator 1646, 134.

Other system embodiments are also described herein, either directly or derivable as system versions of described processes or configured media, duly informed by the extensive discussion herein of computing hardware.

Although specific CSVR architecture examples are shown in the Figures, an embodiment may depart from those examples. For instance, items shown in different Figures may be included together in an embodiment, items shown in a Figure may be omitted, functionality shown in different items may be combined into fewer items or into a single item, items may be renamed, or items may be connected differently to one another.

Examples are provided in this disclosure to help illustrate aspects of the technology, but the examples given within this document do not describe all of the possible embodiments. A given embodiment may include additional or different kinds of CSVR functionality, for example, as well as different technical features, aspects, interfaces, mechanisms, software, expressions, operational sequences, commands, data structures, programming environments, execution environments, environment or system characteristics, agents, proxies, or other functionality consistent with teachings provided herein, and may otherwise depart from the particular examples provided.

Processes (a.K.a. Methods)

Processes (which are also referred to as “methods” in the legal sense of that word) are illustrated in various ways herein, both in text and in drawing figures. FIGS. 17 and 18 each illustrate a family of methods 1700 and 1800 respectively, which are performed or assisted by some enhanced systems, such as some systems 202 or another functionality enhanced system as taught herein. Method family 1700 is a proper subset of method family 1800. Moreover, activities are identified in FIGS. 1 to 16 as explicit or implicit method steps are likewise incorporated into method 1800, e.g., forming an electrical connection 1608, adding or removing or changing a load 502, switching a mode 1614, controlling a frequency 1616, employing a bus 1506 communication protocol (e.g., Inter-Integrated Circuit, Serial Peripheral Interface, or Universal Asynchronous Receiver/Transmitter), sensing a temperature 1620, sensing a current 1612, and so on. Also, steps that are not expressly tied herein to a particular reference number are not thereby excluded from method 1800. These diagrams and flowcharts are merely examples; as noted elsewhere, any operable combination of steps that are disclosed herein may be part of a given embodiment when called out in a claim.

Technical processes shown in the Figures or otherwise disclosed will be performed automatically, e.g., by an enhanced system 202, unless otherwise indicated. Related non-claimed processes may also be performed in part automatically and in part manually to the extent action by a human person is implicated, e.g., in some situations a human 104 actuates a power switch to allow electric power into a system 202. Regardless, no process contemplated as an embodiment herein is entirely manual or purely mental; none of the claimed processes can be performed solely in a human mind or on paper. Any claim interpretation to the contrary is squarely at odds with the present disclosure.

In a given embodiment zero or more illustrated steps of a process may be repeated, perhaps with different parameters or data to operate on. Steps in an embodiment may also be done in a different order than the top-to-bottom order that is laid out in FIG. 18. FIG. 18 is a supplemental portion of the textual and figure drawing examples of embodiments provided herein and the descriptions of embodiments provided herein. In the event of any alleged inconsistency, lack of clarity, or excessive breadth due to an interpretation of FIG. 18, the content of this disclosure shall prevail over that interpretation of FIG. 18.

Arrows in process or data flow figures indicate allowable flows; arrows pointing in more than one direction thus indicate that flow may proceed in more than one direction. Steps may be performed serially, in a partially overlapping manner, or fully in parallel within a given flow. In particular, the order in which flowchart 1800 action items are traversed to indicate the steps performed during a process may vary from one performance instance of the process to another performance instance of the process. The flowchart traversal order may also vary from one process embodiment to another process embodiment. Steps may also be omitted, combined, renamed, regrouped, be performed on one or more machines, or otherwise depart from the illustrated flow, provided that the process performed is operable and conforms to at least one claim of an application or patent that includes or claims priority to the present disclosure. To the extent that a person of skill considers a given sequence S of steps which is consistent with FIG. 18 to be non-operable, the sequence S is not within the scope of any claim. Any assertion otherwise is contrary to the present disclosure.

Some embodiments provide or utilize a cross-stage voltage regulation method 1800 which is performed in an electrical system 214. The electrical system includes an upstream voltage regulator in an upstream voltage regulation stage and a downstream voltage regulator in a downstream voltage regulation stage. The upstream voltage regulator has an upstream voltage regulator output line, the downstream voltage regulator has a downstream voltage regulator input line and a downstream voltage regulator output line. The downstream voltage regulator input line is electrically connected to receive an incoming downstream voltage which is regulated at least in part by the upstream voltage regulator. The electrical system also includes a cross-stage sensing path and a cross-stage voltage regulation mechanism. The cross-stage sensing path is external to the downstream voltage regulator input line and electrically connects the downstream voltage regulation stage to the upstream voltage regulation stage. This voltage regulation method 1800, which in some embodiments is performed automatically and proactively, includes: the electrical system transmitting 1702 an outgoing downstream voltage 132 from the downstream voltage regulator output line through at least the cross-stage sensing path to the cross-stage voltage regulation mechanism; and the cross-stage voltage regulation mechanism regulating 1704 an outgoing upstream voltage of the upstream voltage regulator output line in response to at least the transmitted outgoing downstream voltage.

In some embodiments, regulating 1704 is accomplished using commercially available or otherwise familiar voltage regulation circuitry which is adapted to receive cross-stage voltage information as a basis of the regulation activity 1704. Suitable adaptation varies according to the embodiment. Some example adaptations include electrically connecting the voltage regulation circuitry to the sensing path 210, configuring the voltage regulation circuitry to respond to events 222 from a different VR stage instead of responding to in-stage events, and configuring the voltage regulation circuitry to receive and respond to the outgoing downstream voltage instead of responding to an upstream voltage.

In some embodiments, a cross-stage sensing propagation time 1602 is less than half 1828 of a stage-by-stage propagation time 1606. The cross-stage sensing propagation time is defined as a first elapsed time 1604 between a voltage change 222 on the downstream voltage regulator output line and an arrival via at least the cross-stage sensing path 210 of a corresponding sensed voltage change 222 at the voltage regulation mechanism of the upstream voltage regulator. The stage-by-stage propagation time is defined as second elapsed time 1604 between the voltage change 222 on the downstream voltage regulator output line and an arrival via at least the downstream voltage regulator input line and the upstream voltage regulator output line of a corresponding responsive voltage change 222 at a connection 1608 of the upstream voltage regulator output line to the upstream voltage regulator. In some variations, the cross-stage sensing propagation time is less than M % of the stage-by-stage propagation time, where M is 40, 30, 25, 20, 10, 5, or 1, depending on the particular embodiment.

In some embodiments, regulating 1704 an outgoing upstream voltage of the upstream voltage regulator output line in response to at least the transmitted outgoing downstream voltage includes adjusting 1802 the upstream voltage regulator and thereby reducing 1804 a difference between a reference voltage 1610 and the outgoing upstream voltage.

In some embodiments, regulating 1704 an outgoing upstream voltage of the upstream voltage regulator output line in response to at least the transmitted outgoing downstream voltage includes switching 1806 a mode 1614 of the upstream voltage regulator, and thereby changing 1808 a current 1612 on the upstream voltage regulator output line. Some examples of a mode 1614 include a pulse skip mode, a performance mode, a high-efficiency mode, or a low power mode. Some examples in some scenarios switch 1806 fast enough to avoid droop.

In some embodiments, regulating 1704 an outgoing upstream voltage of the upstream voltage regulator output line in response to at least the transmitted outgoing downstream voltage includes at least one of: altering 1810 a frequency 1616 of the upstream voltage regulator; altering 1812 a duty cycle 1618 of the upstream voltage regulator; or altering 1814 a power state 1836 of the upstream voltage regulator.

### Configured Storage Media

Some embodiments include a configured computer-readable storage medium 112. Some examples of storage medium 112 include disks (magnetic, optical, or otherwise), RAM (random access memory), EEPROMs (electronically erasable read-only memories) or other ROMs (read-only memories), and other configurable memory, including in particular computer-readable storage media (which are not mere propagated signals). In some embodiments, the storage medium which is configured is in particular a removable storage medium 114 such as a CD, DVD, or flash memory. A general-purpose memory, which is removable or not, and is volatile or not, depending on the embodiment, can be configured in the embodiment using items in the form of data 118 and instructions 116, read from a removable storage medium 114 and/or another source such as a network connection, to form a configured storage medium. The foregoing examples are not necessarily mutually exclusive of one another.

The configured storage medium 112 is capable of causing a computer system 202 to perform technical process steps for providing or utilizing CSVR functionality 204 as disclosed herein. The Figures thus help illustrate configured storage media embodiments and process (a.k.a. method) embodiments, as well as system and process embodiments. In particular, any of the method steps illustrated in FIG. 17 or 18, or otherwise taught herein, may be used to help configure a storage medium to form a configured storage medium embodiment.

### Additional Observations

Support for the discussion of CSVR functionality 204 herein is provided under various headings. However, it is all intended to be understood as an integrated and integral part of the present disclosure's discussion of the contemplated embodiments. This disclosure is meant to be understood as a whole. In particular, this disclosure is unlikely to be fully and properly understood during or after only a single top-to-bottom pass through its text. For a full and proper understanding, most if not all readers will also use keyword searches, reference numeral searches, correlation of the specification text with the drawing figures, correlation of the claims with the rest of the text and with the drawing figures, and other nonlinear reading approaches, in addition to reading the full text from top to bottom.

One of skill will recognize that not every part of this disclosure, or any particular details therein, are necessarily required to satisfy legal criteria such as enablement, written description, best mode, novelty, nonobviousness, adequate claim support via technical teachings in the description, inventive step, or industrial applicability. Any apparent conflict with any other patent disclosure, even from the owner of the present subject matter, or any reference external to the present disclosure, has no role in interpreting the claims presented in this patent disclosure. It is in the context of this understanding, which pertains to all parts of the present disclosure, that examples and observations are offered herein.

Some embodiments utilize or provide a feed-forward sensing scheme for cascading voltage regulator control. Some embodiments utilize or provide a feed-forward sensing scheme for cascading voltage regulators and controllers to enable a mode-switch ahead of the effects of transient events. In some embodiments, sensing voltage or current across stages of a multistage voltage regulation circuit allows an upstream stage to respond faster to voltage spikes on a downstream stage output.

Some embodiments include a sense line 210, 1624 from a first stage VR to a second stage VR output, thereby directly sensing load transient effects. An advantage here is that the first VR stage reacts to the second stage load. With this CSVR architecture, a first VR control loop has input from the second VR's output, avoiding reliance solely on, and reaction only to, its own output. This way the first VR is prepared for the cascading effects of the load change. Employing this CSVR feature permits an increase in efficiency and performance at selected locations in an electrical system, and saves on inter-stage capacitance (output of first VR, input of second VR being an example).

In some implementations, addition of CSVR functionality includes a VR supplier adding to their design and product a sensing pin or another mechanism for interpreting the next stage voltage. In some embodiments, sensing is done with comparators to change modes based on predefined threshold levels, or digitally translated to a VR controller.

Some embodiments perform, provide, or utilize a voltage regulation method performed by a system, the system including a cascading hierarchy of voltage regulation devices that includes at least a first voltage regulation device and a second voltage regulation device, the method including: the second voltage regulation device encountering a transient load effect 222; the first voltage regulation device sensing the transient load effect through a sensing line which connects the first voltage regulation device to an output of the second voltage regulation device; and the first voltage regulation device commencing reacting to the sensing of the transient load effect prior to the first voltage regulation device receiving an impact of the transient load effect at an output of the first voltage regulation device.

Some embodiments include a voltage regulation mechanism inside an upstream stage regulator that receives the cross-stage sensing line information. In some, a mode switch or a control loop or both are part of an off-the-shelf VR, which is adapted by the addition of the cross-stage sensing line as an input to the mode switch or the control loop.

### Internet of Things

In some embodiments, the system 202 is, or includes, an embedded system such as an Internet of Things system. “IoT” or “Internet of Things” means any networked collection of addressable embedded computing or data generation or actuator nodes. An individual node is referred to as an internet of things device 101 or IoT device 101 or internet of things system 102 or IoT system 102. Such nodes are examples of computer systems 102 as defined herein, and may include or be referred to as a “smart” device, “endpoint”, “chip”, “label”, or “tag”, for example, and IoT may be referred to as a “cyber-physical system”. In the phrase “embedded system” the embedding referred to is the embedding a processor and memory in a device, not the embedding of debug script in source code.

IoT nodes and systems typically have at least two of the following characteristics: (a) no local human-readable display; (b) no local keyboard; (c) a primary source of input is sensors that track sources of non-linguistic data to be uploaded from the IoT device; (d) no local rotational disk storage—RAM chips or ROM chips provide the only local memory; (e) no CD or DVD drive; (f) being embedded in a household appliance or household fixture; (g) being embedded in an implanted or wearable medical device; (h) being embedded in a vehicle; (i) being embedded in a process automation control system; or (j) a design focused on one of the following: environmental monitoring, civic infrastructure monitoring, agriculture, industrial equipment monitoring, energy usage monitoring, human or animal health or fitness monitoring, physical security, physical transportation system monitoring, object tracking, inventory control, supply chain control, fleet management, or manufacturing. IoT communications may use protocols such as TCP/IP (Transmission Control Protocol/Internet Protocol), Constrained Application Protocol (CoAP), Message Queuing Telemetry Transport (MQTT), Advanced Message Queuing Protocol (AMQP), HTTP, HTTPS, Transport Layer Security (TLS), UDP, or Simple Object Access Protocol (SOAP), for example, for wired or wireless (cellular or otherwise) communication. IoT storage or actuators or data output or control may be a target of unauthorized access, either via a cloud, via another network, or via direct local access attempts.

### Technical Character

The technical character of embodiments described herein will be apparent to one of ordinary skill in the art, and will also be apparent in several ways to a wide range of attentive readers.

For example, some embodiments address technical activities such as sensing 1818 a voltage 132 in an electrical system 214 without employing human senses, sensing 1820 a temperature 1620 in an electrical system 214 without employing human senses, and regulating 1704 a voltage 132 in an electrical system 214 without employing human actions to modify regulator 134 behavior, which are each an activity deeply rooted in electrical and electronic technology. The “without employing human senses” and “without employing human actions” qualifiers are stated here explicitly to help prevent misunderstanding by some readers, but they would be understood by one of skill in the art as inherent to the embodiments. These qualifiers shall govern the interpretation of the claims even when not explicitly recited in the claims. To improve readability and reduce disclosure length, these qualifiers are not explicitly repeated throughout this disclosure, but the disclosure should be read as if they were thus repeated.

Moreover, some of the technical mechanisms discussed in this disclosure include, e.g., various examples of functionality 204 software and hardware, voltage regulators 134, mode switches 218, control loop controllers 220, junctions 402, power sources, and loads 502.

In addition, some of the technical effects discussed include, e.g., adjustments 1802 in upstream voltage regulator behavior that are faster 1828 than reactions to a ripple propagation time 1606, alterations 1810, 1812, 1814 in voltage regulator behavior, cross-stage voltage sensing 1818 generally, and voltage sensing 1818 across more than one stage boundary 1832 in particular, and adjustments 1802 in upstream voltage regulator behavior in response to temperate sensing 1820. Other technical effects are also discussed herein, e.g., in the descriptions of technical benefits and technical challenges.

In short, purely mental processes, activities limited to pen-and-paper, and abstract ideas per se are clearly excluded from the scope of any claimed embodiment. Other advantages based on the technical characteristics of the teachings will also be apparent to one of skill from the description provided.

One of skill understands that cross-stage voltage regulation as described herein is a technical activity which cannot be performed mentally at all, because the mechanisms in question lack I/O devices that would allow a human to somehow “read” or “write” voltages within the electrical system at the connection points in question. People do not regulate a voltage, e.g., from 20V to 8V, or invert 1826 a voltage, or communicate with a voltage regulator via a voltage transmission line 210. Hence, electrical and electronic operational improvements such as the various examples of CSVR functionality 204 described herein are improvements to electrical and electronic technology, in the context of computing technology and otherwise. People manifestly lack the physical senses, and the physical properties such as conductivity, resistance, and inductance, as well as the speed, accuracy, and specific electric and electronic capabilities, which are required to perform CSVR as taught herein.

Different embodiments provide different technical benefits or other advantages in different circumstances, but one of skill informed by the teachings herein will acknowledge that particular technical advantages will likely follow from particular embodiment features or feature combinations, as noted at various points herein.

Any generic or abstract aspects of described embodiments are integrated into a practical application, such as a voltage regulator cascade or other multi-stage voltage regulator, or a machine containing an electrical system configured for cross-stage voltage sensing. Some particular machines include cloud computing system machines such as server racks, server blades, and servers, as well as other computing systems, such as videogaming systems, laptops, tablets, and smart phones. Some embodiments are in electrical systems which step down voltages, at the front end of a server rack for example, in a multi-stage implementation such as a 48V to 1V application. However, system power design teachings herein can be applied beneficially in many applications during two stage power conversion with information flowing from one stage to another, in order to increase efficiency, save money on components, increase performance, and reduce energy costs (especially in data centers). The foregoing are examples, not a comprehensive list of all potential practical applications of the present disclosure's teachings.

Teachings herein provide complementary additions to, or alternatives to, attempts to reduce or eliminate the likelihood of transient events, and attempts to reduce the time spent by upstream voltage regulators responding to the propagated effects of transient events.

Many embodiments are suitable for implementation in a single device, but some embodiments also span multiple devices.

Many embodiments are suitable for implementation in off-die voltage regulators, or in on-die voltage regulators. The on-die voltage regulators are on the same die as an SoC or processor in some embodiments, and are packaged in a separate chip in other embodiments.

Some embodiments described herein may be viewed by some people in a broader context. For instance, concepts such as efficiency, reliability, redundancy, or waste may be deemed relevant to a particular embodiment.

However, it does not follow from the availability of a broad context that exclusive rights are being sought herein for abstract ideas; they are not. In particular, no claim is made to power regulation activities generally, as opposed to the particular CSVR methods, systems, and devices described and claimed in the eventual final claims based on the present disclosure.

Rather, the present disclosure is focused on providing appropriately specific embodiments whose technical effects fully or partially solve particular technical problems, such as: how to optimize the handling of voltage dips, voltage spikes, and other transient events in a power supply system that includes multiple voltage regulator stages; and how to reduce response times for mode switches, control loops, and other control elements in a power supply system. Other systems, devices, and processes involving efficiency, reliability, redundancy, or waste are outside the present scope. Accordingly, vagueness, mere abstractness, lack of technical character, and accompanying proof problems are also avoided under a proper understanding of the present disclosure.

### Additional Combinations and Variations

Any combination of logic, components, communications, and/or their functional equivalents may also be combined with any of the systems and their variations described above. A process may include any steps described herein in any subset or combination or sequence which is operable. Each variant may occur alone, or in combination with any one or more of the other variants. Each variant may occur with any of the processes and each process may be combined with any one or more of the other processes. Each process or combination of processes, including variants, may be combined with any of the configured storage medium combinations and variants described above.

More generally, one of skill will recognize that not every part of this disclosure, or any particular details therein, are necessarily required to satisfy legal criteria such as enablement, written description, or best mode. Also, embodiments are not limited to the particular scenarios, motivating examples, operating environments, tools, peripherals, process flows, identifiers, naming conventions, notations, control flows, data flows, topologies, voltages, or other implementation choices described or used herein. Any apparent conflict with any other patent disclosure, even from the owner of the present subject matter, has no role in interpreting the claims presented in this patent disclosure.

### Acronyms, Abbreviations, Names, and Symbols

Some acronyms, abbreviations, names, and symbols are defined below. Others are defined elsewhere herein, or do not require definition here in order to be understood by one of skill.
ALU: arithmetic and logic unit
API: application program interface
BIOS: basic input/output system
CD: compact disc
CPU: central processing unit
DVD: digital versatile disk or digital video disc
FPGA: field-programmable gate array
FPU: floating point processing unit
GDPR: General Data Protection Regulation
GPU: graphical processing unit
GUI: graphical user interface
HTTPS: hypertext transfer protocol, secure
IaaS or IAAS: infrastructure-as-a-service
LAN: local area network
OS: operating system
PaaS or PAAS: platform-as-a-service
RAM: random access memory
ROM: read only memory
TPU: tensor processing unit
UEFI: Unified Extensible Firmware Interface
UI: user interface
WAN: wide area network

### Some Additional Terminology

Reference is made herein to exemplary embodiments such as those illustrated in the drawings, and specific language is used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Sharing a reference numeral does not mean necessarily sharing every aspect, feature, or limitation of every item referred to using the reference numeral. Omission of a reference numeral from a given piece of text does not necessarily mean that the content of a Figure is not being discussed by the text. The present disclosure asserts and exercises the right to specific and chosen lexicography. Quoted terms are being defined explicitly, but a term may also be defined implicitly without using quotation marks. Terms may be defined, either explicitly or implicitly, here in the detailed description and/or elsewhere in the application file.

A “computer system” (a.k.a. “computing system”) may include, for example, one or more servers, motherboards, processing nodes, laptops, tablets, personal computers (portable or not), personal digital assistants, smartphones, smartwatches, smart bands, cell or mobile phones, other mobile devices having at least a processor and a memory, video game systems, augmented reality systems, holographic projection systems, televisions, wearable computing systems, and/or other device(s) providing one or more processors controlled at least in part by instructions. The instructions may be in the form of firmware or other software in memory and/or specialized circuitry.

The term “circuitry” means a set of items which includes at least one trace, bus, line, or other electricity carrier connected to one or more electrical or electronic components (amplifier, inductor, resister, diode, integrated circuit, mode switch, control loop, voltage regulator, power source, etc.). Circuitry does not necessarily contain a loop, i.e., a circuit in a literal sense.

A “multithreaded” computer system is a computer system which supports multiple execution threads. The term “thread” should be understood to include code capable of or subject to scheduling, and possibly to synchronization. A thread may also be known outside this disclosure by another name, such as “task,” “process,” or “coroutine,” for example. However, a distinction is made herein between threads and processes, in that a thread defines an execution path inside a process. Also, threads of a process share a given address space, whereas different processes have different respective address spaces. The threads of a process may run in parallel, in sequence, or in a combination of parallel execution and sequential execution (e.g., time-sliced).

A “processor” is a thread-processing unit, such as a core in a simultaneous multithreading implementation. A processor includes hardware. A given chip may hold one or more processors. Processors may be general purpose, or they may be tailored for specific uses such as vector processing, graphics processing, signal processing, floating-point arithmetic processing, encryption, I/O processing, machine learning, and so on.

“Kernels” include operating systems, hypervisors, virtual machines, BIOS or UEFI code, and similar hardware interface software.

“Code” means processor instructions, data (which includes constants, variables, and data structures), or both instructions and data. “Code” and “software” are used interchangeably herein. Executable code, interpreted code, and firmware are some examples of code.

“Program” is used broadly herein, to include applications, kernels, drivers, interrupt handlers, firmware, state machines, libraries, and other code written by programmers (who are also referred to as developers) and/or automatically generated.

A “routine” is a callable piece of code which normally returns control to an instruction just after the point in a program execution at which the routine was called. Depending on the terminology used, a distinction is sometimes made elsewhere between a “function” and a “procedure”: a function normally returns a value, while a procedure does not. As used herein, “routine” includes both functions and procedures. A routine may have code that returns a value (e.g., sin(x)) or it may simply return without also providing a value (e.g., void functions).

“Service” as a noun means a consumable program offering, in a cloud computing environment or other network or computing system environment, which provides resources to multiple programs or provides resource access to multiple programs, or does both. A service implementation may itself include multiple applications or other programs.

“Cloud” means pooled resources for computing, storage, and networking which are elastically available for measured on-demand service. A cloud may be private, public, community, or a hybrid, and cloud services may be offered in the form of infrastructure as a service (IaaS), platform as a service (PaaS), software as a service (SaaS), or another service. Unless stated otherwise, any discussion of reading from a file or writing to a file includes reading/writing a local file or reading/writing over a network, which may be a cloud network or other network, or doing both (local and networked read/write). A cloud may also be referred to as a “cloud environment” or a “cloud computing environment”.

Herein, activity by a user refers to activity by a user device or activity by a user account or user session, or by software on behalf of a user, or by hardware on behalf of a user. Activity is represented by digital data or machine operations or both in a system. Activity within the scope of any claim based on the present disclosure excludes human actions per se. Software or hardware activity “on behalf of a user” accordingly refers to software or hardware activity on behalf of a user device or on behalf of a user account or a user session or on behalf of another mechanism or computational artifact, and thus does not bring human behavior per se within the scope of any embodiment or any claim.

“Digital data” means data in a computing system, as opposed to data written on paper or thoughts in a person's mind, for example. Similarly, “digital memory” refers to a non-living device, e.g., computing storage hardware, not to human or other biological memory.

As used herein, “include” allows additional elements (i.e., includes means comprises) unless otherwise stated.

“Optimize” means to improve, not necessarily to perfect. For example, it may be possible to make further improvements in a program or an algorithm which has been optimized.

“Process” is sometimes used herein as a term of the computing science arts, and in that technical sense encompasses computational resource users, which may also include or be referred to as coroutines, threads, tasks, interrupt handlers, application processes, kernel processes, procedures, or object methods, for example. As a practical matter, a “process” in a computing system is a computational entity identified by system utilities such as Windows® Task Manager, Linux® ps, or similar utilities in other operating system environments (marks of Microsoft Corporation, Linus Torvalds, respectively). “Process” may also be used as a patent law term of art, e.g., in describing a process claim as opposed to a system claim or an article of manufacture (configured storage medium) claim. Similarly, “method” is used herein primarily as a patent law term of art (akin to a “method”) but it is also a technical term in the computing science arts (a kind of “routine”). “Process” and “method” in the patent law sense are used interchangeably herein. Those of skill will understand which meaning is intended in a particular instance, and will also understand that a given claimed process or method (in the patent law sense) may sometimes be implemented using one or more processes or methods (in the computing science sense).

“Automatically” means by use of automation (e.g., general purpose computing hardware configured by software for specific operations and technical effects discussed herein), as opposed to without automation. In particular, steps performed “automatically” are not performed by hand on paper or in a person's mind, although they may be initiated by a human person or guided interactively by a human person. Automatic steps are performed with a machine in order to obtain one or more technical effects that would not be realized without the technical interactions thus provided. Steps performed automatically are presumed to include at least one operation performed proactively.

One of skill understands that technical effects are the presumptive purpose of a technical embodiment. The mere fact that calculation is involved in an embodiment, for example, and that some calculations can also be performed without technical components (e.g., by paper and pencil, or even as mental steps) does not remove the presence of the technical effects or alter the concrete and technical nature of the embodiment, particularly in real-world embodiment implementations. Voltage regulation operations such as sensing voltage, sensing temperature, adjusting voltage regulator behavior, and many other operations discussed herein (whether recited expressly in the Figures or not), are understood to be inherently electrical. A human mind cannot interface directly with a voltage regulator output line to sense the necessary physical phenomena such as voltage to perform the voltage regulation steps 1800 taught herein. This would all be well understood by persons of skill in the art in view of the present disclosure. Moreover, one of skill understands that CSVR functionality 204 cannot be implemented merely with conventional tools and steps, because actual implementation requires the use of teachings which were first provided in the present disclosure, e.g., cross-stage sensing teachings that support the recited technical effects and technical operations.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein.

Computational results are faster, broader, deeper, more accurate, more consistent, more comprehensive, and/or otherwise provide technical effects that are beyond the scope of human performance alone. “Computational steps” are steps performed computationally. Neither “automatically” nor “computationally” necessarily means “immediately”. “Computationally” and “automatically” are used interchangeably herein.

“Proactively” means without a direct request from a user, and indicates machine activity rather than human activity. Indeed, a user may not even realize that a proactive step by an embodiment was possible until a result of the step has been presented to the user. Except as otherwise stated, any computational and/or automatic step described herein is presumptively done proactively in at least some of the embodiments.

“Based on” means computationally based on at least, not based exclusively on. Thus, a calculation based on X depends on at least X, and may also depend on Y.

Throughout this document, use of the optional plural “(s)”, “(es)”, or “(ies)” means that one or more of the indicated features is present. For example, “processor(s)” means “one or more processors” or equivalently “at least one processor”.

“At least one” of a list of items means one of the items, or two of the items, or three of the items, and so on up to and including all N of the items, where the list is a list of N items. The presence of an item in the list does not require the presence of the item (or a check for the item) in an embodiment. For instance, if an embodiment of a system is described herein as including at least one of A, B, C, or D, then a system that includes A but does not check for B or C or D is an embodiment, and so is a system that includes A and also includes B but does not include or check for C or D. Similar understandings pertain to items which are steps or step portions or options in a method embodiment. This is not a complete list of all possibilities; it is provided merely to aid understanding of the scope of “at least one” that is intended herein.

In claims and elsewhere herein, labels such as (a), (b), etc. in a method description are meant to aid legibility of the description, not to impose a strict order or a total ordering of actions in the method. For instance, steps labeled as (a), (b), etc. for convenience may overlap in some embodiments, or interleave in some embodiments. Step performance order may nonetheless be indicated by verb tenses, or be indicated otherwise to one of skill such as when completion of one step is a practical or prerequisite to another step.

For the purposes of United States law and practice, use of the word “step” herein, in the claims or elsewhere, is not intended to invoke means-plus-function, step-plus-function, or 35 United State Code Section 112 Sixth Paragraph/Section 112(f) claim interpretation. Any presumption to that effect is hereby explicitly rebutted.

For the purposes of United States law and practice, the claims are not intended to invoke means-plus-function interpretation unless they use the phrase “means for”. Claim language intended to be interpreted as means-plus-function language, if any, will expressly recite that intention by using the phrase “means for”. When means-plus-function interpretation applies, whether by use of “means for” and/or by a court's legal construction of claim language, the means recited in the specification for a given noun or a given verb should be understood to be linked to the claim language and linked together herein by virtue of any of the following: appearance within the same block in a block diagram of the figures, denotation by the same or a similar name, denotation by the same reference numeral, a functional relationship depicted in any of the figures, a functional relationship noted in the present disclosure's text. For example, if a claim limitation recited a “zac widget” and that claim limitation became subject to means-plus-function interpretation, then at a minimum all structures identified anywhere in the specification in any figure block, paragraph, or example mentioning “zac widget”, or tied together by any reference numeral assigned to a zac widget, or disclosed as having a functional relationship with the structure or operation of a zac widget, would be deemed part of the structures identified in the application for zac widgets and would help define the set of equivalents for zac widget structures.

One of skill will recognize that this disclosure discusses various data values and data structures, and recognize that such items reside in a memory (RAM, disk, etc.), thereby configuring the memory. One of skill will also recognize that this disclosure discusses various algorithmic steps which are to be embodied in executable code in a given implementation, and that such code also resides in memory, and that it effectively configures any general-purpose processor which executes it, thereby transforming it from a general-purpose processor to a special-purpose processor which is functionally special-purpose hardware.

Accordingly, one of skill would not make the mistake of treating as non-overlapping items (a) a memory recited in a claim, and (b) a data structure or data value or code recited in the claim. Data structures and data values and code are understood to reside in a computer system memory, even when a claim does not explicitly recite that residency for each and every data structure or data value or piece of code mentioned. Accordingly, explicit recitals of such residency are not required. However, they are also not prohibited, and one or two select recitals may be present for emphasis, without thereby excluding all the other data values and data structures and code from residency. Likewise, code functionality recited in a claim is understood to configure a computer system hardware processor, regardless of whether that configuring quality is explicitly recited in the claim.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a computational or other electronic or electrical device step on behalf of a party of interest, such as adjusting, altering, boosting, bucking, changing, connecting (electrically or mechanically or both), crossing, inputting, inverting, outputting, propagating, receiving, reducing, regulating, sensing, switching, transmitting (and adjusts, adjusted, alters, altered, etc.) with regard to a destination or other subject may involve intervening action, such as the foregoing or any action recited in this disclosure or inherent in a step recited in this disclosure, yet still be understood as being performed directly by or on behalf of the party of interest. Example verbs listed here may overlap in meaning or even be synonyms; separate verb names do not dictate separate functionality in every case.

Some people have asserted, outside the present disclosure, that certain verbs indicate human activity, particularly human mental activity. Regardless of their accuracy in other contexts, those assertions are not a correct and accurate basis for the interpretation of any claim supported by the present disclosure, regardless of where they were made. No reference outside the present disclosure to human action associated with a given verb can provide a legally correct basis for the interpretation of any verb recited in any claim supported by the present disclosure. For example, all of the determining described and claimed herein is artificial activity, not human activity.

It is well-established in patent law that proper interpretation of a claim begins with the claim itself, then looks to other claims, then seeks meaning for the claim and its limitations in view of the supporting specification, including the disclosure's text and any drawing figures, while applying the viewpoint of a person skilled in the art. To be reasonable, any claim interpretation must be consistent with the specification. Only if the meaning of claim language remains unclear after considering the claims and their supporting disclosure does it become proper to look for interpretive guidance at any use of the claim language outside the four corners of the patent application itself.

Relying on external assertions to establish that certain verbs denote human activity elsewhere and therefore also denote mental steps or other human activity within claims is legally incorrect. Such reliance is arbitrary and capricious when the specification clearly teaches that such human activity is outside the scope of the claims, as the current specification clearly teaches. Relying on such external assertions is also disrespectful of the efforts of patent practitioners and inventors to make it clear that human activity is not being claimed.

To the extent any human activity is arguably within the scope of any claim based on the present disclosure, that human activity scope is hereby expressly disclaimed and expressly disavowed. Human-machine interaction may be properly noted in a claim for context, e.g., when a claim recites that a user input is received by a computing system. But only the portion of the effective claim scope which is computational and supported herein by the description of electrical systems, electronic components, electrical system components, computing hardware, interfaces, algorithms, data structures, and/or other non-human mechanisms, as understood by one of skill in the art, is retained.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, a memory or other storage device or other computer-readable storage medium is not a propagating signal or a carrier wave or mere energy outside the scope of patentable subject matter under United States Patent and Trademark Office (USPTO) interpretation of the In re Nuijten case. No claim covers a signal per se or mere energy in the United States, and any claim interpretation that asserts otherwise in view of the present disclosure is unreasonable on its face. Unless expressly stated otherwise in a claim granted outside the United States, a claim does not cover a signal per se or mere energy.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory and computer readable storage devices are not propagating signal or carrier wave computer readable media. Unless expressly stated otherwise in the claim, “computer readable medium” means a computer readable storage medium, not a propagating signal per se and not mere energy.

An “embodiment” herein is an example. The term “embodiment” is not interchangeable with “the invention”. Embodiments may freely share or borrow aspects to create other embodiments (provided the result is operable), even if a resulting combination of aspects is not explicitly described per se herein.

Requiring each and every permitted combination to be explicitly and individually described is unnecessary for one of skill in the art, and would be contrary to policies which recognize that patent specifications are written for readers who are skilled in the art. Formal combinatorial calculations and informal common intuition regarding the number of possible combinations arising from even a small number of combinable features will also indicate that a large number of aspect combinations exist for the aspects described herein. Accordingly, requiring an explicit recitation of each and every combination would be contrary to policies calling for patent specifications to be concise and for readers to be knowledgeable in the technical fields concerned.

### Remarks Regarding Reference Numerals

Reference numerals are provided for convenience and in support of the drawing figures and as part of the text of the specification, which collectively describe aspects of embodiments by reference to multiple items. Items which do not have a unique reference numeral may nonetheless be part of a given embodiment. For better legibility of the text, a given reference numeral is recited near some, but not all, recitations of the referenced item in the text. The same reference numeral may be used with reference to different examples or different instances of a given item.

A list of multiple reference numerals given with an item, e.g., language similar to “item 1, 2, 3”, indicates that the item is an example of a respective category associated with each listed reference numeral. For example, “laptop 101, 102” indicates that a laptop is both a machine 101 and a computing system 102. A relevant distinction in this example is that a computing system 102 contains one or more machines 101, whereas reference numeral 101 refers to a single machine, e.g., a single laptop, a single smartphone, a single workstation, a single Internet of Things device, etc. Similarly, particular kinds of data are referred to on occasion with two reference numbers, one of which is 118 indicating data generally, and the other of which refers to a particular category of data, e.g., temperature values, voltage values, or another data category, depending on the functionality being described. However, reference numerals for more general categories are often omitted herein for better readability, particularly when one of skill would acknowledge that the more general category encompasses a more specific category whose reference numeral is recited.

The following remarks pertain to particular reference numerals:
100 operating environment, also referred to as computing environment; includes one or more systems 102
101 machine in a system 102, e.g., any device having at least a processor 110 and having a distinct identifier such as an IP address or a MAC (media access control) address; may be a physical machine or be a virtual machine implemented on physical hardware
102 computer system, also referred to as a “computational system” or “computing system”, and when in a network may be referred to as a “node”
104 users, e.g., user of an enhanced system 202
106 peripheral device
108 network generally, including, e.g., LANs, WANs, software-defined networks, clouds, and other wired or wireless networks
110 processor or non-empty set of processors; includes hardware
112 computer-readable storage medium, e.g., RAM, hard disks; also referred to as storage device
114 removable configured computer-readable storage medium
116 instructions executable with processor; may be on removable storage media or in other memory (volatile or nonvolatile or both)
118 digital data in a system 102; data structures, values, source code, and other examples are discussed herein
120 kernel(s), e.g., operating system(s), BIOS, UEFI, device drivers; also refers to an execution engine such as a language runtime
122 software tools, software applications, DEP software, security controls; hardware tools; computational
124 cloud, also referred to as cloud environment or cloud computing environment
126 display screens, also referred to as “displays”
128 hardware, software, or hardware-software combination that is not otherwise associated with a reference numeral 106, 108, 110, 112, 114, e.g., power supply, application program interface (API), network interface
130 user interface hardware and software
132 voltage; refers to actual voltage in an electrical system or to a digital value or an analog value (but not a mental value) from a voltage measurement or estimate or reference value
134 voltage regulator; includes electronic or electrical hardware; artificial not a natural item such as a tree or a human; composed of one or more connected individual voltage regulator stages
136 voltage regulator stage, i.e., an individual voltage regulator
138 interface generally, e.g., network interface card, API, user interface, or other mechanism by or through which separable items communicate in a computing system, where examples of separable include physically separable, separately compilable, separately installable, or separably replaceable without loss of functionality
202 enhanced system, i.e., system 102 enhanced with functionality 204 as taught herein
204 cross-stage voltage regulation functionality (also referred to as functionality 204, CSVR functionality, or a cross-stage voltage regulated electrical system 204), e.g., a mechanism which performs or is configured to perform steps 1702 and 1704, or any mechanism which performs or is configured to perform a sequence of voltage regulation activities first disclosed herein, or to perform a novel method voltage regulation method 1800 first disclosed herein, or which includes a cross-stage sensing path 210
1700 flowchart; 1700 also refers to CSVR methods that are illustrated by or consistent with the FIG. 17 flowchart or any variation of the FIG. 17 flowchart described herein
1800 flowchart; 1800 also refers to CSVR methods that are illustrated by or consistent with the FIG. 18 flowchart, which incorporates the flowchart of FIG. 17, the steps implicit or express in FIGS. 1 through 16, and all other steps taught herein, or methods that are illustrated by or consistent with any variation of the FIG. 18 flowchart described herein; all CSVR method steps are computational or otherwise artificial, not human activity
1834 any step or item discussed in the present disclosure that has not been assigned some other reference numeral; 1834 may thus be shown expressly as a reference numeral for various steps or items or both, and may be added as a reference numeral (in the current disclosure or any subsequent patent application which claims priority to the current disclosure) for various steps or items or both without thereby adding new matter

### Conclusion

Some embodiments provide or utilize technology to regulate voltage 132 in an electrical system 214. An example electrical system 214 includes a first voltage regulator 134, a second voltage regulator 134, a cross-stage sensing path 210, and a cross-stage voltage regulation mechanism 212. The cross-stage sensing path 210 is external to an input line 206, 1624 of the first voltage regulator 134 and connected 1608 to an output line 208, 1624 of the second voltage regulator 134. The cross-stage voltage regulation mechanism 212 is connected 1608 to the cross-stage sensing path 210 and configured to regulate 1704 an outgoing voltage 132 of the first voltage regulator 134 in response to receipt 1816 through at least the cross-stage sensing path 210 of an outgoing voltage 132 from the second voltage regulator 134 output line 208. The cross-stage voltage regulation mechanism 212 includes a mode switch 218 or a control loop 220. Some variations include more than two voltage regulators 134, more than one cross-stage sensing path 210, paths 210 that cross 1830 more than one stage boundary 1832, more than one cross-stage voltage regulation mechanism 212, temperature 1620 sensing 1820, other variations described in the present disclosure, and combinations thereof.

Embodiments are understood to also themselves include or benefit from tested and appropriate security controls and privacy controls such as the General Data Protection Regulation (GDPR). Use of the tools and techniques taught herein can be used together with such controls.

Although Microsoft technology is used in some motivating examples, the teachings herein are not limited to use in technology supplied or administered by Microsoft. Under a suitable license, for example, the present teachings could be embodied in hardware provided by other vendors.

Although particular embodiments are expressly illustrated and described herein as processes, as configured storage media, or as systems, it will be appreciated that discussion of one type of embodiment also generally extends to other embodiment types. For instance, the descriptions of processes in connection with the Figures also help describe configured storage media, and help describe the technical effects and operation of systems and manufactures like those discussed in connection with other Figures. It does not follow that any limitations from one embodiment are necessarily read into another. In particular, processes are not necessarily limited to the data structures and arrangements presented while discussing systems or manufactures such as configured memories.

Those of skill will understand that implementation details may pertain to specific details, such as specific thresholds, voltages, topologies, voltage regulator types, electrical system architectures, and specific operating environments, and thus need not appear in every embodiment. Those of skill will also understand that component identifiers and some other terminology used in discussing details are implementation-specific and thus need not pertain to every embodiment. Nonetheless, although they are not necessarily required to be present here, such details may help some readers by providing context and/or may illustrate a few of the many possible implementations of the technology discussed herein.

With due attention to the items provided herein, including technical processes, technical effects, technical mechanisms, and technical details which are illustrative but not comprehensive of all claimed or claimable embodiments, one of skill will understand that the present disclosure and the embodiments described herein are not directed to subject matter outside the technical arts, or to any idea of itself such as a principal or original cause or motive, or to a mere result per se, or to a mental process or mental steps, or to a business method or prevalent economic practice, or to a mere method of organizing human activities, or to a law of nature per se, or to a naturally occurring thing or process, or to a living thing or part of a living thing, or to a mathematical formula per se, or to isolated software per se, or to a merely conventional computer, or to anything wholly imperceptible or any abstract idea per se, or to insignificant post-solution activities, or to any method implemented entirely on an unspecified apparatus, or to any method that fails to produce results that are useful and concrete, or to any preemption of all fields of usage, or to any other subject matter which is ineligible for patent protection under the laws of the jurisdiction in which such protection is sought or is being licensed or enforced.

Reference herein to an embodiment having some feature X and reference elsewhere herein to an embodiment having some feature Y does not exclude from this disclosure embodiments which have both feature X and feature Y, unless such exclusion is expressly stated herein. All possible negative claim limitations are within the scope of this disclosure, in the sense that any feature which is stated to be part of an embodiment may also be expressly removed from inclusion in another embodiment, even if that specific exclusion is not given in any example herein. The term “embodiment” is merely used herein as a more convenient form of “process, system, article of manufacture, configured computer readable storage medium, and/or other example of the teachings herein as applied in a manner consistent with applicable law. ” Accordingly, a given “embodiment” may include any combination of features disclosed herein, provided the embodiment is consistent with at least one claim.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole. Distinct steps may be shown together in a single box in the Figures, due to space limitations or for convenience, but nonetheless be separately performable, e.g., one may be performed without the other in a given performance of a method.

Reference has been made to the figures throughout by reference numerals. Any apparent inconsistencies in the phrasing associated with a given reference numeral, in the figures or in the text, should be understood as simply broadening the scope of what is referenced by that numeral. Different instances of a given reference numeral may refer to different embodiments, even though the same reference numeral is used. Similarly, a given reference numeral may be used to refer to a verb, a noun, and/or to corresponding instances of each, e.g., a processor 110 may process 110 instructions by executing them.

As used herein, terms such as “a”, “an”, and “the” are inclusive of one or more of the indicated item or step. In particular, in the claims a reference to an item generally means at least one such item is present and a reference to a step means at least one instance of the step is performed. Similarly, “is” and other singular verb forms should be understood to encompass the possibility of “are” and other plural forms, when context permits, to avoid grammatical errors or misunderstandings.

Headings are for convenience only; information on a given topic may be found outside the section whose heading indicates that topic.

All claims and the abstract, as filed, are part of the specification. The abstract is provided for convenience and for compliance with patent office requirements; it is not a substitute for the claims and does not govern claim interpretation in the event of any apparent conflict with other parts of the specification. Similarly, the summary is provided for convenience and does not govern in the event of any conflict with the claims or with other parts of the specification. Claim interpretation shall be made in view of the specification as understood by one of skill in the art; it is not required to recite every nuance within the claims themselves as though no other disclosure was provided herein.

To the extent any term used herein implicates or otherwise refers to an industry standard, and to the extent that applicable law requires identification of a particular version of such as standard, this disclosure shall be understood to refer to the most recent version of that standard which has been published in at least draft form (final form takes precedence if more recent) as of the earliest priority date of the present disclosure under applicable patent law.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A cross-stage voltage regulation method performed in an electrical system which includes an upstream voltage regulator in an upstream voltage regulation stage and a downstream voltage regulator in a downstream voltage regulation stage, the upstream voltage regulator having an upstream voltage regulator output line, the downstream voltage regulator having a downstream voltage regulator input line and a downstream voltage regulator output line, the downstream voltage regulator input line being electrically connected to receive an incoming downstream voltage which is regulated at least in part by the upstream voltage regulator, the electrical system also including a cross-stage sensing path and a cross-stage voltage regulation mechanism, the cross-stage sensing path being external to the downstream voltage regulator input line and electrically connecting the downstream voltage regulation stage to the upstream voltage regulation stage, the voltage regulation method comprising:
the electrical system transmitting an outgoing downstream voltage from the downstream voltage regulator output line through at least the cross-stage sensing path to the cross-stage voltage regulation mechanism; and
the cross-stage voltage regulation mechanism regulating an outgoing upstream voltage of the upstream voltage regulator output line in response to at least the transmitted outgoing downstream voltage.

2. The voltage regulation method of claim 1, wherein a cross-stage sensing propagation time is less than half of a stage-by-stage propagation time, the cross-stage sensing propagation time being defined as a first elapsed time between a voltage change on the downstream voltage regulator output line and an arrival via at least the cross-stage sensing path of a corresponding sensed voltage change at the voltage regulation mechanism of the upstream voltage regulator, the stage-by-stage propagation time being defined as second elapsed time between the voltage change on the downstream voltage regulator output line and an arrival via at least the downstream voltage regulator input line and the upstream voltage regulator output line of a corresponding responsive voltage change at a connection of the upstream voltage regulator output line to the upstream voltage regulator.

3. The voltage regulation method of claim 1, wherein regulating an outgoing upstream voltage of the upstream voltage regulator output line in response to at least the transmitted outgoing downstream voltage comprises adjusting the upstream voltage regulator and thereby reducing a difference between a reference voltage and the outgoing upstream voltage.

4. The voltage regulation method of claim 1, wherein regulating an outgoing upstream voltage of the upstream voltage regulator output line in response to at least the transmitted outgoing downstream voltage comprises switching a mode of the upstream voltage regulator and thereby changing a current on the upstream voltage regulator output line.

5. The voltage regulation method of claim 1, wherein regulating an outgoing upstream voltage of the upstream voltage regulator output line in response to at least the transmitted outgoing downstream voltage comprises at least one of:
altering a frequency of the upstream voltage regulator;
altering a duty cycle of the upstream voltage regulator; or
altering a power state of the upstream voltage regulator.

6. A cross-stage voltage regulation subsystem in an electrical system, the electrical system comprising an upstream voltage regulator in an upstream voltage regulation stage and a downstream voltage regulator in a downstream voltage regulation stage, the upstream voltage regulator having an upstream voltage regulator output line, the downstream voltage regulator having a downstream voltage regulator input line and a downstream voltage regulator output line, the downstream voltage regulator input line being electrically connected to receive an incoming downstream voltage which is regulated at least in part by the upstream voltage regulator, the voltage regulation subsystem comprising:
a cross-stage sensing path external to the downstream voltage regulator input line and connectable to the downstream voltage regulator output line; and a
cross-stage voltage regulation mechanism connectable to the cross-stage sensing path and configured to regulate an outgoing upstream voltage of the upstream voltage regulator output line in response to receipt through at least the cross-stage sensing path of at least an outgoing downstream voltage from the downstream voltage regulator output line.

7. The voltage regulation subsystem of claim 6, wherein the cross-stage sensing path comprises a voltage sensing line connectable to the downstream voltage regulator output line, and the cross-stage sensing path further comprises at least one of:
a current sensing path;
a temperature sensing path; or
an energy usage meter.

8. The voltage regulation subsystem of claim 6, wherein the cross-stage voltage regulation mechanism comprises at least one of:
a mode switch; or
a control loop.

9. The voltage regulation subsystem of claim 6 in an electrically connected combination with the upstream voltage regulator and the downstream voltage regulator which forms a combination system, wherein the cross-stage sensing path electrically connects the downstream voltage regulator output line to the cross-stage voltage regulation mechanism.

10. The combination system of claim 9, comprising at least three voltage regulators which have different respective output voltages, and which are electrically connected in a serial topology.

11. The combination system of claim 9, comprising at least three voltage regulators which are electrically connected in at least one of:
a many-to-one topology; or
a one-to-many topology.

12. The combination system of claim 9, wherein at least one of the upstream voltage regulator or the downstream voltage regulator comprises an off-die voltage regulator.

13. The combination system of claim 9, wherein at least one of the upstream voltage regulator or the downstream voltage regulator comprises an on-die voltage regulator.

14. The combination system of claim 9, wherein at least one of:
the upstream voltage regulator comprises an in-stage upstream voltage sensing line which senses the outgoing upstream voltage of the upstream voltage regulator output line, the in-stage upstream voltage sensing line external to the cross-stage sensing path; or
the downstream voltage regulator comprises an in-stage downstream voltage sensing line which senses the outgoing downstream voltage of the downstream voltage regulator output line, the in-stage downstream voltage sensing line external to the cross-stage sensing path.

15. A cross-stage voltage regulated electrical system which includes voltage regulators with respective input lines and output lines, the system comprising:
a first voltage regulator in a first voltage regulation stage, the first voltage regulator having an input line, having an output line, and being configured to provide a first voltage on the output line;
a second voltage regulator in a second voltage regulation stage, the second voltage regulator having an input line, having an output line, and being configured to provide a second voltage on the output line, the second voltage being different from the first voltage;
a cross-stage sensing path which is external to the second voltage regulator input line, external to the first voltage regulator output line, and electrically connected to the second voltage regulator output line;
a cross-stage voltage regulation mechanism electrically connected to the cross-stage sensing path and configured to regulate the first voltage in response to receipt by way of the cross-stage sensing path of at least the second voltage; and
wherein “first” and “second” herein distinguish items without necessarily indicating a relative position in time or in space.

16. The system of claim 15, wherein the system has a topology, the topology includes a tree having branches, and the first voltage regulator is on a different branch than the second voltage regulator.

17. The system of claim 15, wherein the first voltage regulator is in series with the second voltage regulator.

18. The system of claim 15, wherein the first voltage regulator is in parallel with the second voltage regulator.

19. The system of claim 15, wherein the first voltage regulator or the second voltage regulator or both comprise at least one of:
a boost convertor;
a buck convertor; or
an inverter.

20. The system of claim 15, wherein the first voltage regulator or the second voltage regulator or both comprise at least one of:
a linear voltage regulator; or
a switching regulator.
